(19) United States
(12) Patent Application Publication
(10) Pub. No.: US 2019/0258115 A1
(43) Pub. Date: Aug. 22, 2019

(54) LIGHTING DEVICE AND DISPLAY DEVICE

(71) Applicant: SHARP KABUSHIKI KAISHA, Sakai City, Osaka (JP)

(72) Inventors: YOUZOU KYOUKANE, Sakai City (JP); HISASHI WATANABE, Sakai City (JP); HIROTOSHI YASUNAGA, Sakai City (JP)

(21) Appl. No.: 16/342,391

(22) PCT Filed: Oct. 19, 2017
(86) PCT No.: PCT/JP2017/037802

§ 371 Date: Apr. 16, 2019

(30) Foreign Application Priority Data
Oct. 26, 2016 (JP) 2016-209744

(51) Int. Cl. G02F 1/1335

(52) U.S. Cl. CPC G02F 1/133606; G02F 1/133608; G02F 1/133605; G02F 1/133603

(57) ABSTRACT

A lighting device includes light sources, an optical member, a light-transmissive support portion, and a light scattering portion. The light sources are planarly arranged at intervals. The optical member is disposed on a light exit side to face the plurality of light sources at an interval. The light-transmissive support portion is disposed to be interposed between the adjacent light sources. The light-transmissive support portion is configured to support the optical member by being brought into contact with the optical member from the light source side, and having light transmissivity. The light scattering portion is provided on at least a light irradiation portion of the light-transmissive support portion irradiated with light from the light source.

### TECHNICAL FIELD

The present invention relates to a lighting device and a display device.

### BACKGROUND ART

As an example of the light source unit of a conventional liquid crystal display device, the light source unit disclosed in patent document 1 is known. The light source unit disclosed in patent document 1 includes a fiat fluorescent lamp, a diffusion plate disposed on the light-emitting surface side of the flat fluorescent lamp, and a support member disposed on the light-emitting surface side of the flat fluorescent lamp so as to support the diffusion plate. This support member has a base and support projections. The two ends of the base are fixed. More specifically, the support member is fixed between the flat fluorescent lamp and a holding member by being fitted in a notched portion formed in the holding member.

### RELATED ART DOCUMENTS

Patent Document 1: Japanese Patent Laid-Open No. 2008-21533

### Problem to be Solved by the Invention

The light source unit disclosed in patent document 1 described above has the diffusion plate supported by the support projections of the support member. This support member is made of a transparent plastic material, and hence transmits light emitted from the flat fluorescent lamp. However, abutment portions of the support projections which abut against the diffusion plate tend to be visually recognized as dark portions because it is difficult for light transmitted through the support projections to reach the abutment portions. This causes luminance irregularity, posing a problem to be solved.

### DISCLOSURE OF THE PRESENT INVENTION

The present invention has been completed based on the above situation, and has as its object to suppress the occurrence of luminance irregularity.

### Means for Solving the Problem

A lighting device includes light sources, an optical member, a light-transmissive support portion, and a light scattering portion. The light sources are planarly arranged at intervals. The optical member is disposed on a light exit side to face the plurality of light sources at an interval. The light-transmissive support portion is disposed to be interposed between the adjacent light sources. The light-transmissive support portion is configured to support the optical member by being brought into contact with the optical member from the light source side, and having light, transmissivity. The light scattering portion is provided on at least a light irradiation portion of the light-transmissive support portion irradiated with light from the light source.

With this arrangement, light emitted from the plurality of light sources planarly arranged at intervals exits to the outside upon being given an optical effect by the optical member arranged at intervals on the light exit side to face the plurality of light sources. The light-transmissive support portion support the optical member by being brought into contact with the optical member from the light source side, thereby keeping the intervals between the plurality of light sources and optical members. Although the light-transmissive support portion is interposed between the adjacent light sources, the light-transmissive support portion has light transmissivity. This prevents light from the light sources from being shielded, thereby making it difficult to recognize the overall light-transmissive support portion as a dark portion. On the other hand, because it is difficult for light transmitted through the light-transmissive support portion to reach the abutment portion of the light-transmissive support portion against the optical member, the abutment portion can be a dark portion. In contrast to this, because the light scattering portions that, scatter light are provided on the light irradiation portions of the light-transmissive support portion which are irradiated with at least light from the light sources, when the light-transmissive support portion is irradiated with light from the light sources, the light is scattered by the light scattering portions provided on the light, irradiation portions. At least part of the light reaches the abutment portions of the light-transmissive support portion against the optical member. This makes it difficult to recognize the abutment portions of the light-transmissive support portion against the optical member as dark portions, thereby suppressing the occurrence of luminance irregularity.

An embodiment of the present invention preferably has the following arrangements.

(1) The light scattering portion is formed from a rough surface formed on the light irradiation portion on an external surface of the light-transmissive support portion. With this arrangement, because light from each light source applied to the light irradiation portion on the external surface of the light-transmissive support portion is scattered by the light scattering portion formed from a rough surface formed on the light irradiation portion, at least part of the light reaches the abutment portion of the light-transmissive support portion against the optical member, thereby making it difficult to recognize the abutment portion as a dark portion. The above rough surface can be formed at the time of the manufacture of the light-transmissive support portion or formed by processing a manufactured light-transmissive support portion. Accordingly, this technique is excellent in terms of manufacturing cost and convenience as compared with a case, for example, light scattering particles that scatter light are blended in a light-transmissive support portion.

(2) The light-transmissive support portion is inclined with respect to an arranging direction of the light sources so as to increase in distance from the light sources as the external surface approaches the optical member. This can reduce the area of each abutment portion of the light-transmissive support portion against the optical member as compared with the case in which the external surface of the light-transmissive support portion is perpendicular to the arranging direction of the light sources. This makes it difficult to recognize the abutment portion of the light-transmissive support portion against the optical member as a dark portion, thereby making it more suitable to suppress the occurrence of luminance irregularity.

(3) The light-transmissive support portion has a partition wall shape that partitions between the adjacent light sources. With this arrangement, the light-transmissive support portion having the partition wall shape partitions between the adjacent light sources. When so-called local dimming control is performed so as to selectively control the ON/OFF of a plurality of light sources, it is difficult for light from the ON light sources to leak to the OFF light sources. Therefore, it is possible to control the amount of light emitted from the lighting device for further each small area. In addition, the abutment portion of the optical member against the light-transmissive support portion has a linear shape. This increases the support stability of the optical member by the light-transmissive support portion as compared with a case in which, for example, the abutment portion has a dot shape.

(4) The light-transmissive support portion has a lattice shape that individually partitions between the plurality of light sources. With this arrangement, the plurality of light sources are individually partitioned by the light-transmissive support portion having the lattice shape, and hence it is possible to control the amount of light emitted from the lighting device for further each small area. In addition, this further increases the mechanical strength of the light-transmissive support portion, and hence further increases the support stability of the optical member by the light-transmissive support portion.

(5) The light-transmissive support portion has a columnar shape. With this arrangement, each abutment portion of the light-transmissive support portion against the optical member has a dot shape. This reduces the area of the abutment portion of the light-transmissive support portion against the optical member as compared with a case in which, for example, the abutment portion has a linear shape. This makes it more difficult to visually recognize the abutment portion of the light-transmissive support portion against the optical member as a dark portion, thereby making it more suitable to suppress the occurrence of luminance irregularity. In addition, this arrangement is suitable to reduce the manufacturing cost of the light-transmissive support portion.

(6) The light scattering portions are provided on the irradiation portions of the light-transmissive support portion throughout the entire circumference. With this arrangement, even if the light-transmissive support portion having a columnar shape is irradiated with light from the light sources from all directions in the circumferential direction, the light can be properly scattered by the light scattering portions. This makes it possible for more light to reach each abutment portion of the light-transmissive support portion against the optical member.

(7) The optical member includes at least a planar diffusion material for diffusing light. With this arrangement, light from each light source exits to the outside while being diffused by the planar diffusion material. When at least, part of light from the light source which is scattered by the light scattering portion of the light-transmissive support portion reaches the abutment portion of the light-transmissive support portion against the planar diffusion material, the light exits to the outside while being diffused by the planar diffusion material. This makes it difficult to visually recognize the abutment portion of the light-transmissive support portion against the planar diffusion material as a dark portion.

(8) The optical member includes at least a planar reflecting material with light-transmissive portions that is a planar reflecting material configured to reflect light, includes light-transmissive portions, and increases in distribution density of light-transmissive portions with an increase in distance from the light sources. With this arrangement, when light from each light source reaches light-transmissive portions of the planar reflecting material with light-transmissive portions, the light exits to the outside, whereas when the light is reflected by a portion, of the planar reflecting material with the light-transmissive portions, in which no light-transmissive portion is formed, the light is temporarily returned to the light source side and then reaches the light-transmissive portion to exit to the outside. Because the distribution density of light-transmissive portions in the planar reflecting material with the light-transmissive portions increases with an increase in distance from the light sources, the exit of light to the outside is suppressed near light sources with relatively large amounts of light, whereas the exit of light to the outside is promoted at positions far from light sources with relatively small amounts of light. This uniformizes the amounts of light exiting to the outside. At least part of light from each light source which is scattered by light scattering portions of the light-transmissive support portion reaches the abutment portion of the light-transmissive support portion against the planar reflecting material with the light-transmissive portions. When this light is transmitted through the light-transmissive portion, the light exits to the outside. When the light is reflected by the planar reflecting material with the light-transmissive portions, the light is returned to the light source side again.

(9) The optical member includes at least a planar diffusion material with reflecting portions that is a planar reflecting material configured to diffuse light, and decreases in distribution density of reflecting portions with an increase in distance from the light sources. With this arrangement, when light from each light source Teaches a portion, of the planar diffusion material with the reflecting portions, on which no reflecting portion is formed, the light exits to the outside while being diffused. When this light is reflected by the reflecting portion, the light is temporarily returned to the light source side and reaches the portion on which no reflecting portion is formed to exit to the outside while being diffused. The distribution density of reflecting portions of the planar diffusion material with the reflecting portions decreases with an increase in distance from each light source. Accordingly, the exit of light to the outside is suppressed near light, sources with relatively large mounts of light, whereas the exit of light to the outside is promoted at positions far from light sources with relatively small amounts of light. This uniformizes the amounts of light exiting to the outside. At least part of light from each light source which is scattered by light scattering portions of the light-transmissive support portion reaches the abutment portion of the light-transmissive support portion against the planar diffusion material with the reflecting portions. When this light is transmitted through the portion on which no reflecting portion is formed, the light exits to the outside while being diffused. When the light is reflected by the reflecting portion, the light is returned to the light source side again.

In order to solve the above problems, the display device according to the present invention includes the above lighting device and a display panel that displays images by using light emitted from the lighting device. The display device having this arrangement makes it difficult to cause luminance irregularity of light from the lighting device, thereby implementing display with excellent display quality.

### Advantageous Effect of the Invention

The present invention can suppress the occurrence of luminance irregularity.

### BRIEF DESCRIPTION OF THE DRAWINGS

FIG. 1 is a plan view of a backlight device constituting a liquid crystal display device according to the first embodiment of the present invention;

FIG. 2 is a partial sectional view of the liquid crystal display device taken along the long side direction;

FIG. 3 is a partial sectional view of the liquid crystal display device taken along the short side direction;

FIG. 4 is an enlarged perspective view showing an LED and the lattice-shaped support portion of a support member;

FIG. 5 is an enlarged sectional view of the lattice-shaped support portion;

FIG. 6 is a partial sectional view of a backlight device according to the second embodiment of the present invention taken along the long side direction;

FIG. 7 is an enlarged plan view of a backlight device according to the third embodiment of the present invention;

FIG. 8 is a partial sectional view of the backlight device taken along the long side direction;

FIG. 9 is a plan view of a backlight device according to the fourth embodiment of the present invention;

FIG. 10 is an enlarged plan view of the backlight device;

FIG. 11 is a partial sectional view of the backlight device taken along the long side direction;

FIG. 12 is a partial sectional view of a backlight device according to the fifth embodiment of the present invention taken along the long side direction;

FIG. 13 is a partial sectional view of a backlight device according to the sixth embodiment of the present invention taken along the long side direction;

FIG. 14 is a plan view of a backlight device according to the seventh embodiment of the present invention;

FIG. 15 is a plan view of a backlight device according to the eighth embodiment of the present invention;

FIG. 16 is a plan view of a backlight device according to the ninth embodiment of the present invention; and

FIG. 17 is an enlarged sectional view of a lattice-shaped support portion according to the 10th embodiment of the present invention.

### BEST MODE FOR CARRYING OUT THE INVENTION

### First Embodiment

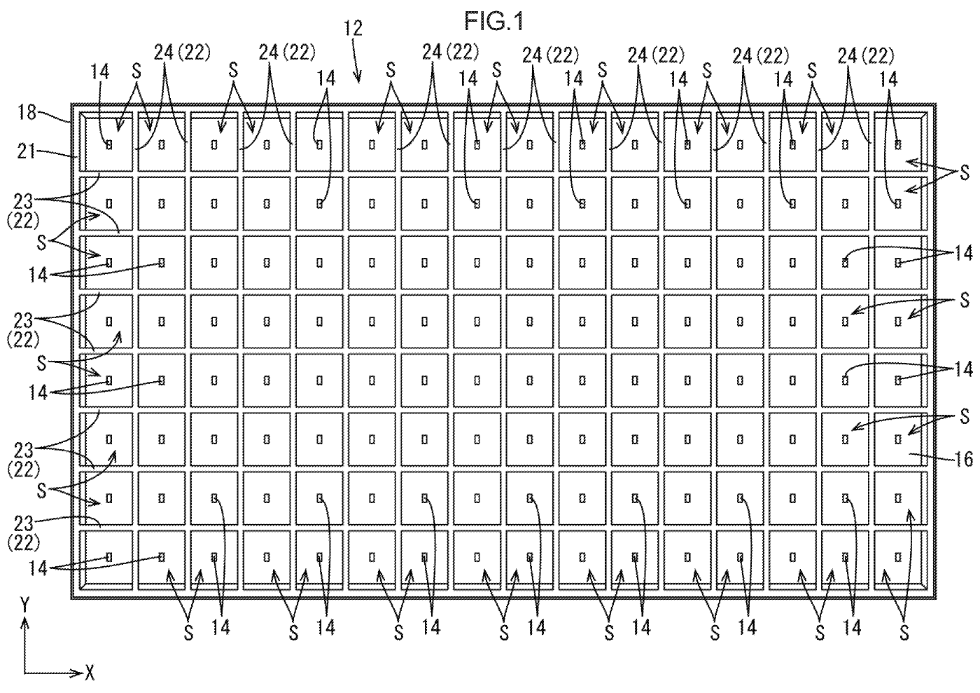

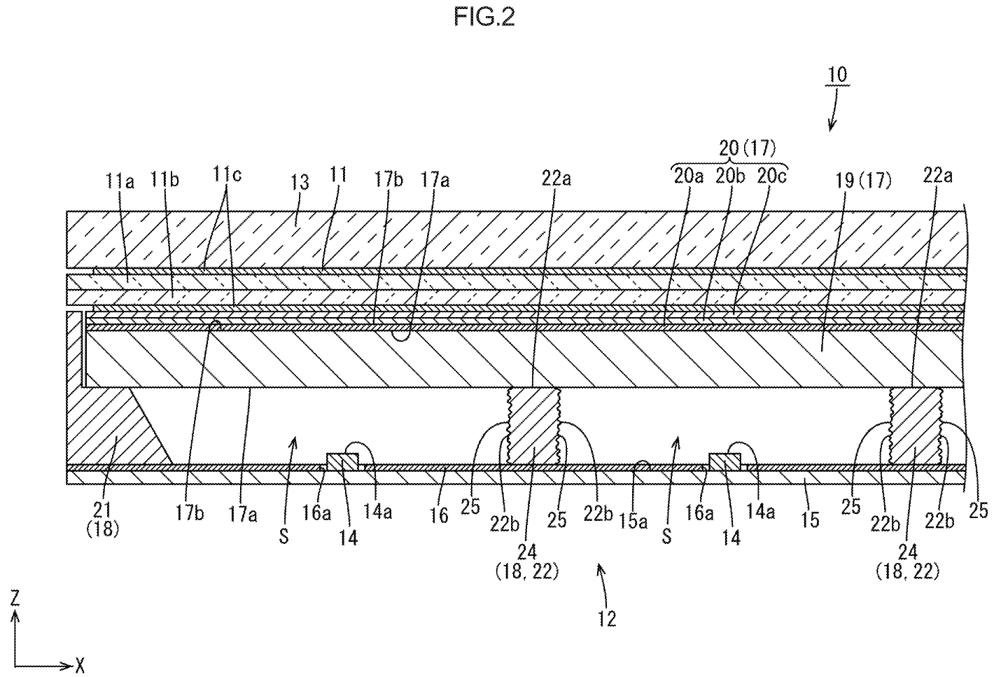

The first embodiment of the present invention will be described with reference to FIGS. 1 to 5. This embodiment will exemplify a liquid crystal display device (display device) 10. Note that part of each drawing shows the X-, Y-, and Z-axes, and the respective axial directions coincide with the directions indicated on each drawing. The upper side of each of FIGS. 2, 3, and 5 corresponds to the front side, and the lower side corresponds to the back side.

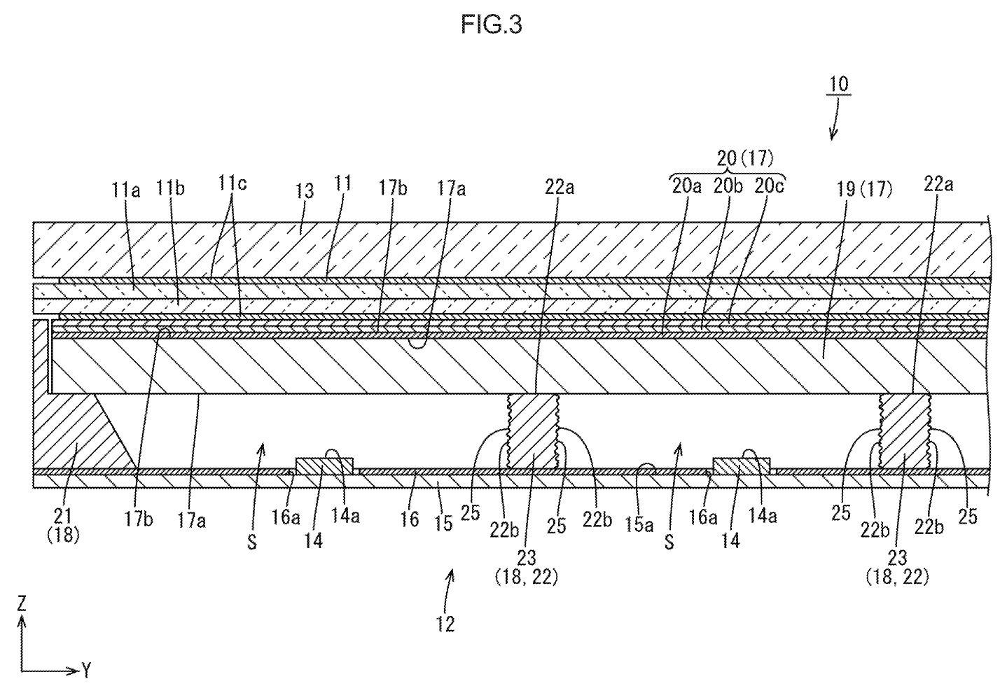

The liquid crystal display device 10 has a rectangular shape as a whole. As shown in FIGS. 2 and 3, the liquid crystal display device 10 includes at least a liquid crystal panel (display panel) 11 that can display images, a backlight device (lighting device) 12 as an external light source that irradiates the liquid crystal panel 11, disposed on the back side (light incident side) relative to the liquid crystal panel 11, with light for display, and a cover glass (protective panel) 13 that is disposed so as to overlap the front side (light exit side) relative to the liquid crystal panel 13. The liquid crystal panel 11 and the cover glass 13, which overlap each other, are fixed to each other throughout almost the entire area through an almost transparent fixing layer (not shown) made of, for example, OCA (Optical Clear Adhesive). The outer circumferential end portions (non-display regions and ineffective light exit regions) of the liquid crystal panel 11 and the backlight device 12 are fixed to each other through a light-shielding fixing tape (not shown) obtained by, for example, coating the both surfaces of a base material having a light-shielding property with an adhesive agent.

The cover glass 13 will be briefly described first. As shown in FIGS. 2 and 3, the cover glass 13 is disposed so as to cover the front side of the liquid crystal panel 11 through almost the entire area. This can protect the liquid crystal panel 11. The cover glass 13 is made of glass that is almost transparent and having excellent light transmissivity and formed into a plate shape so as to have a rectangular shape in a planar view. The cover glass 13 is preferably made of reinforced glass. As reinforced glass used for the cover glass 13, for example, chemically reinforced glass is preferably used, which has a chemically reinforced layer on its surface which is formed by applying a chemically reinforcing treatment to a surface of a plate glass base material.

The liquid crystal panel (display panel) 11 has a rectangular shape in a planar view like the cover glass 13, and is configured such that a pair of glass substrates 11a and 11b are bonded to each other through a predetermined gap, and a liquid crystal layer (not shown) containing liquid crystal molecules as a material that changes in optical property accompanying the application of an electric field is sealed between the substrates 11a and 11b. The array substrate (active matrix substrate) 11b, of the pair of substrates 11a and 11b, which is disposed on the back side is provided with switching elements (for example, TFTs) connected to orthogonal source and gate lines each other, pixel electrodes connected to the switching elements, an alignment film, and the like. The CF substrate (counter substrate) 11a disposed on the front side is provided with a color filter with colored portions such as R (Red), G (Green), and B (Blue) portions being arranged in a predetermined array, light-shielding portions (black matrix) partitioning between the adjacent colored portions, a counter electrode, an alignment film, and the like. The display surface of the liquid crystal panel 11 is segmented into a display area (active area) which is disposed on the central side and on which an image is displayed and a non-display area (nonactive area) which is disposed on the outer circumferential end side so as to form a frame shape surrounding the display area and on which no image is displayed. Note that a pair of front and back polarizing plates 11c are respectively bonded to the external surface sides of the pair to substrates 11a and 11b.

The backlight device 12 will be described in detail next. As shown in FIG. 1, the backlight device 12 has a rectangular shape in a planar view like the liquid crystal panel 11 and the cover glass 13. As shown in FIGS. 2 and 3, the backlight device 12 includes a plurality of LEDs (light sources) 14 planarly arranged, an LED substrate 15 on which the LEDs 14 are mounted, a reflecting sheet (reflecting member) 16 disposed so as to cover the LED substrate 15 and reflect light, a plate or sheet-like (planar) optical member (planar optical member) 17 disposed on the light exit side of the LEDs 14 with a space between them, and a support member 18 disposed between the optical member 17 and the LED substrate 15 so as to support the optical member 17. In this manner, the backlight device 12 according to this embodiment has the LEDs 14 disposed immediately below the liquid crystal panel 11 and the optical member 17 such that light-emitting surfaces 14a face the liquid crystal panel 11 and the optical member 17, thereby implementing a direct-lighting backlight. Each constituent element of the backlight device 12 will be described in detail below.

As shown in FIGS. 2 and 3, each LED 14 is of a so-called top-surface emitting type in which the LED 14 is surface-mounted on the LED substrate 15, and the light-emitting surface 14a faces the opposite side to the LED substrate 15. The LEDs 14 are arranged in a positional relationship in which the light-emitting surfaces 14a face the optical member 17 with a space between them in the Z-axis direction (the normal direction of the surface of the optical member 17). The LED 14 is configured such that an LED chip (LED element or light-emitting element) is sealed with a resin material on a substrate portion fixed on the plate surface of the LED substrate 15. Each LED chip mounted on a substrate portion is of a single main light-emitting wavelength type. More specifically, each LED chip designed to emit blue light as monochromatic light is used. On the other hand, a resin material for sealing each LED chip is dispersed and blended with a phosphor that emits light of a predetermined color (red light, green light, blue light, or the like) by being excited by blue light emitted from the LED chip. The LED chips emit approximately white light as a whole.

As shown in FIGS. 1 to 3, the LED substrate 15 has almost the same plate shape as the liquid crystal panel 11 and the cover glass 13 in terms of size and shape in a planar view. The long side direction (lengthwise direction), short side direction (widthwise direction), and thickness direction of the LED substrate 15 respectively coincide with the X-axis direction, Y-axis direction, and Z-axis direction. The LEDs 14, each having the above arrangement, are surface-mounted on the plate surface, of the LED substrate 15, which faces the front side (optical member 17 side). This plate surface serves as a mounting surface 15a The LEDs 14 are planarly arranged at intervals within the mounting surface 15a of the LED substrate 15, and more specifically, arranged in a matrix pattern at intervals in the X-axis direction and the Y-axis direction respectively. The arrangement intervals between the adjacent LEDs 14 are almost constant (equal intervals). The base material of the LED substrate 15 is a rigid substrate made of a metal such as an aluminum-based material. A wiring pattern (not shown) formed from a metal film such as a copper foil film is formed or an insulating layer on the surface of the LED substrate 15. The wiring pattern connects the adjacent LEDs 14 in series. As a material used for the base material of the LED substrate 15, an insulating material such as ceramics can be used.

The reflecting sheet 16 has a white surface with excellent reflectivity, and has a size that covers the front side of the LED substrate 15 throughout almost the entire area. As shown in FIGS. 2 and 3, LED insertion holes (light source insertion holes) 16a are formed in the reflecting sheet 16 at positions overlapping the respective LEDs 14 in a planar view. Each LED 14 extends through a corresponding one of the LED insertion holes 16a The LED insertion holes 16a are arranged in a matrix pattern in the X-axis direction and the Y-axis direction, respectively, in correspondence with the arrangement of the LEDs 14.

As shown in FIGS. 2 and 3, the optical member 17 has almost the same plate shape or sheet-like shape as that of the liquid crystal panel 11 or the like in terms of size and shape in a planar view. The optical member 17 is interposed between the liquid crystal panel 11 and each LED 14 in the Z-axis direction, and has a function of causing light emitted from the LED 14 to exit toward the liquid crystal panel 11 while giving a predetermined optical effect to the light. The optical member 17 is disposed on the front side relative to each LED 14, that is, the light exit side, so as to face it at a predetermined interval. The support member 18 described later supports the optical member 17 from the back side so as to maintain the interval between the optical member 17 and each LED 14 almost constant. Of the pair of front and back surfaces of the optical member 17, the back surface on which light from the LED 14 is incident serves as a light incident surface 17a. In contrast to this, the front surface serves as a light exit surface 17b from which light transmitted through the front surface exits. Accordingly, the light incident surface 17a of the optical member 17 faces the light-emitting surface 14a of each LED 14. The light exit surface 17b of the optical member 17 is segmented into an effective light exit region which is a central portion and causes light to effectively exit and an ineffective light exit region which is an outer circumferential portion surrounding the effective light exit portion and inhibits light from effectively exiting. This effective light exit region is a range in which exit light can be effectively used by being supplied to the display region of the liquid crystal panel 11. This range overlaps the display region in a planar view.

As shown in FIGS. 2 and 3, the optical member 17 is constituted by a diffusion plate (planar diffusion material) 19 relatively disposed on the back side (the LED 14 side or light incident side) and a plurality of optical sheets 20 relatively disposed on the front side (the liquid crystal panel 11 side or light exit side). The diffusion plate 19 is formed by dispersing many diffusing particles into a base material made of an almost transparent synthetic resin material (for example, polycarbonate or acryl) thicker than the optical sheets 20, and has a function of diffusing transmitted light. The diffusion plate 19 is the optical member 17 directly supported by the support member 18 described later. The plurality (three in this embodiment) of optical sheets 20 are stacked on each other. More specifically, a diffusion sheet 20a, a first prism sheet 20b, and a second prism sheet 20c are sequentially stacked from the back side (diffusion plate 19 side). The diffusion sheet 20a is formed by dispersing many diffusing particles into a base material made of an almost transparent synthetic resin material thinner than the diffusion plate 19, and has a function of diffusing transmitted light. The first prism sheet 20b and the second prism sheet 20c each are formed by arranging many prisms extending along the X-axis direction or the Y-axis direction on a plate surface of a base material made of an almost transparent synthetic resin material thinner than the diffusion plate 19 along the X-axis direction or Y-axis direction and are configured to selectively give a light condensing action to transmitted light only in the arranging direction of the prisms. The first prism sheet 20b and the second prim sheet 20c are arranged such that the extending directions of the prisms on the respective sheets are orthogonal to each other.

The support member 18 is made of an almost transparent synthetic resin material (polycarbonate or acryl) having excellent light transmissivity. As shown in FIGS. 2 and 3, the support member 18 is interposed between the LED substrate 15 and the optical member 17 in the Z-axis direction so as to restrict the deformation such as distortion of the planar optical member 17, thereby maintaining the interval (optical distance) between each LED 14 and the optical member 17 constant in the Z-axis direction. The support member 18 is disposed such that its part (a lattice-shaped support portion 22 described later) is interposed between the adjacent LEDs 14 but has light transmissivity, and hence prevents light from each LED 14 from being shielded. This improves the utilization efficiency (luminance) of light as compared with a case in which, for example, a support member has a light-shielding property, thereby making it difficult to visually recognize the support member 18 (the lattice-shaped support portion 22 in particular) as a dark portion. More specifically, the luminance of light exiting from the backlight device 12 can be improved by about 7% as compared with a case in which, for example, the support member has a light-shielding property.

As shown in FIG. 1, the support member 18 is constituted by a frame-shaped support portion 21 having a frame shape along the outer circumferential end portion as the ineffective light exit region of the optical member 17 and the lattice-shaped support portion (light-transmissive support portion) 22 disposed on the mounting surface 15a of the LED substrate 15 so as to be interposed between the LEDs 14 arranged in a matrix pattern and having a lattice shape so as to individually partition each LED 14. The frame-shaped support portion 21 is formed by connecting the end portions of each pair of long side portions extending along a long side of the optical member 17 and each pair of short side portions extending along a short side of the optical member 17, and supports the outer circumferential end portion of the optical member 17, that is, the ineffective light exit region, from the back side throughout almost the entire circumference. As shown in FIGS. 2 and 3, the surface (the abutment surface against the optical member 17) of the frame-shaped support portion 21 which faces the front side has a planar shape parallel to the light incident surface 17a of the optical member 17, whereas the internal surface (the surface facing each partition space S) is inclined relative to the light incident surface 17a of the optical member 17 throughout almost the entire circumference.

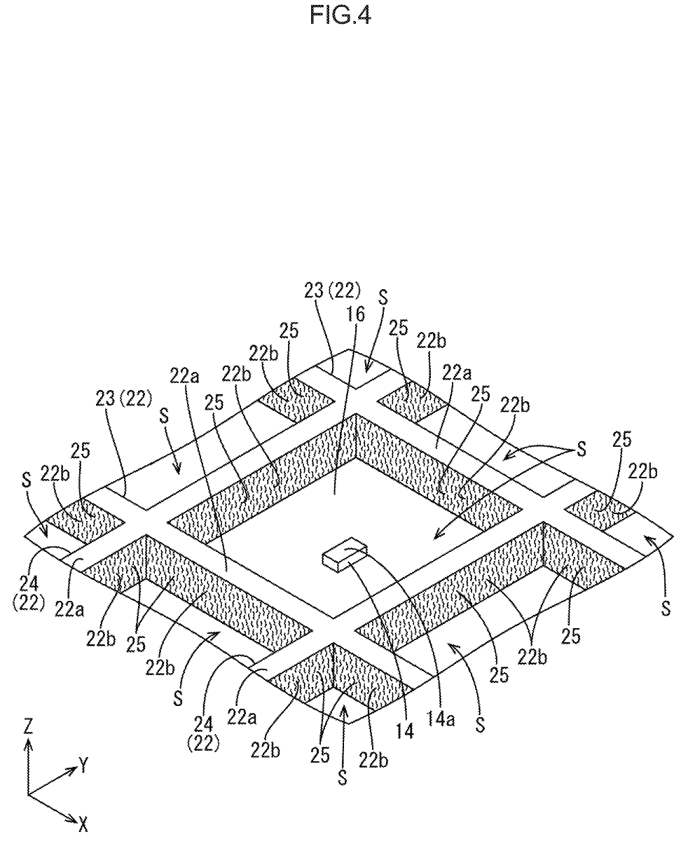

As shown in FIGS. 2 and 3, the lattice-shaped support portion 22 supports the central portion of the optical member 17 excluding the outer circumferential end portion, that is, mainly the effective light exit region, from the back side. As shown in FIGS. 1 and 4, the lattice-shaped support portion 22 includes a plurality of first partition walls 23 linearly extending along the X-axis direction and a plurality of second partition walls 24 linearly extending along the Y-axis direction, and is formed by connecting the intersecting portions between the first partition walls 23 and the second partition walls 24 to each other. The first partition walls 23 are interposed between the LEDs 14 arranged along the Y-axis direction to individually partition between the respective LEDs 14, and are disposed at intermediate positions between the adjacent LEDs 14 in the Y-axis direction. That is, the first partition walls 23 and the LEDs 14 are alternately arranged in the Y-axis direction. More specifically, the first partition walls 23 are arrayed at an equal pitch in the Y-axis direction at the same intervals as those between the LEDs 14 adjacent to each other in the Y-axis direction. The number of placed first partition walls 23 is the number obtained by subtracting 1 from the number of LEDs 14 arrayed in the Y-axis direction. The second partition walls 24 are interposed between the LEDs 14 arranged along the X-axis direction to individually partition between the respective LEDs 14, and are disposed at intermediate positions between the adjacent LEDs 14 in the X-axis direction. That is, the second partition walls 24 and the LEDs 14 are alternately arranged in the X-axis direction. More specifically, the second partition walls 24 are arrayed at an equal pitch in the X-axis direction at the same intervals as those between the LEDs 14 adjacent to the second partition walls 24 in the X-axis direction. The number of placed second partition walls 24 is the number obtained by subtracting 1 from the number of LEDs 14 arrayed in the X-axis direction. As shown in FIGS. 2 and 3, the lattice-shaped support portion 22 is configured such that the surfaces facing the front side, that is, abutment surfaces (abutment portions) 22a against the optical member 17, each have a planar shape parallel to the light incident surface 17a of the optical member 17, whereas side surfaces 22b are almost perpendicular (normal) to the light incident surface 17a of the optical member 17. That is, the first partition walls 23 and the second partition walls 24 of the lattice-shaped support portion 22 each have a width dimension (thickness dimension) is almost constant in the overall height range (the entire area in the Z-axis direction).

As shown in FIGS. 2 and 3, the frame-shaped support portion 21 and the lattice-shaped support portion 22 constituting the support member 18 each are in contact with the light incident surface 17a of the diffusion plate 19 of the optical, member 17. Accordingly, the space between the LED substrate 15 and the diffusion plate 19 is partitioned into a plurality of partition spaces S for the respective LEDs 14 by the frame-shaped support portion 21 and the lattice-shaped support portion 22. As shown in FIG. 1, each partition space S has a square shape in a planar view. The partition spaces S (equal in number to the LEDs 14 arranged) are arranged side by side in the X-axis direction and the Y-axis direction in a matrix pattern. Each partition space S overlaps the effective light exit region of the optical member 17 in a planar view. As shown in FIGS. 1 and 4, the four sides of the LED 14 disposed at each outermost circumferential position on the LED substrate 15 are surrounded by the frame-shaped support portion 21, the first partition wall 23, and the second partition wall 24, whereas the four sides of each LED 14 disposed closer to the center than the LED 14 disposed at each outermost circumferential position are surrounded by one pair of first partition walls 23 and one pair of second partition walls 24. The LEDs 14 arranged on the LED substrate 15 in a matrix pattern are arranged in the partition spaces S each partitioned by the frame-shaped support portion 21 and the lattice-shaped support portion 22. Accordingly, when so-called local dimming control is performed to selectively control ON/OFF of each LED 14, it is difficult for light from each ON LED 14 to leak to the partition space S side in which each adjacent OFF LED 14 is disposed. This can control permission and inhibition of the supply of light to the effective light exit region of the diffusion plate 19 for each partition space S, thereby controlling the amount of light emitted from the backlight device 12 for each partition space S. In addition, because the support member 18 has light transmissivity, light is transmitted between the adjacent partition spaces S to some extent. This makes it difficult for the user to visually recognize the boundaries between the adjacent partition spaces S, thereby achieving excellent display quality.

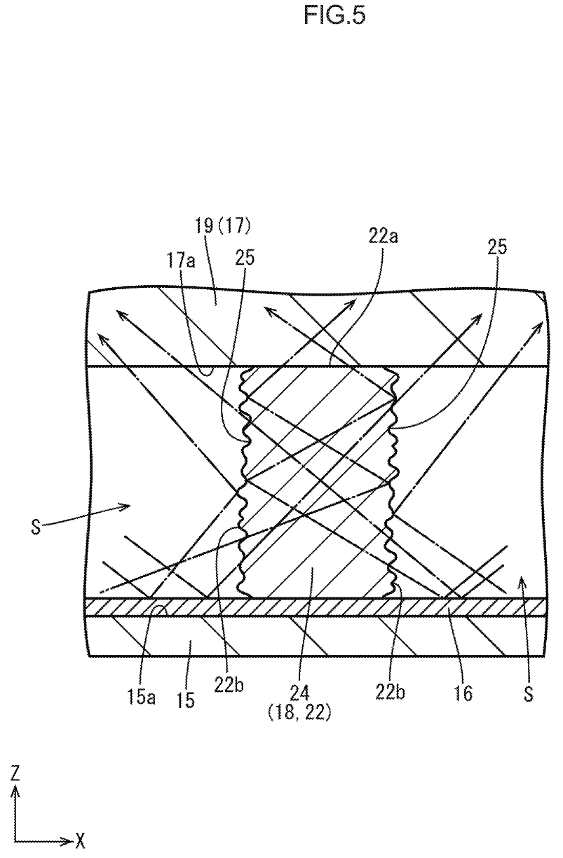

As shown in FIGS. 2 to 4, the lattice-shaped support portion 22 of the support member 18 which is interposed between the adjacent LEDs 14 is provided with light scattering portions 25 that scatter light. The light scattering portions 25 are provided on the side surfaces (external surfaces) 22b which are light irradiation portions that are irradiated with light from the LEDs 14. The light scattering portion 25 is provided throughout the entire height range and the entire length range, that is, almost the entire area, of each of the side surfaces 22b of the first partition walls 23 and the second partition walls 24 constituting the lattice-shaped support portion 22. Referring to FIG. 4, the formation ranges of the light scattering portions 25 are indicated by hatching. Each side surface 22b of the lattice-shaped support portion 22 is provided to directly face the partition space S in which the LED 14 is disposed, and hence is irradiated with light existing in the partition space S. More specifically, each side surface 22b of the lattice-shaped support portion 22 is directly irradiated with light emitted from the light-emitting surface 14a of the LED 14, indirectly irradiated with light that is emitted from the LED 14 and reflected by the optical member 17 and the liquid crystal panel 11, and also indirectly irradiated with light that is reflected by the optical member 17, the liquid crystal panel 11, and the like and further reflected by the reflecting sheet 16. Light with which each side surface 22b of the lattice-shaped support portion 22 is irradiated originally has predetermined directivity but becomes omnidirectional light scattered in all directions by being scattered by the light scattering portion 25, as shown in FIG. 5. Accordingly, at least part of the light scattered by the light scattering portion 25 reaches the abutment surface 22a that is an abutment portion of the lattice-shaped support portion 22 against the diffusion plate 19. Assume that each side surface 22b of the lattice-shaped support portion 22 is provided with no light scattering portion. In this case, light with which the side surface 22b of the lattice-shaped support portion 22 is irradiated travels and is transmitted through the lattice-shaped support portion 22 while having predetermined directivity, and hence it is difficult for the light, to reach the abutment surface 22a. As a result, the abutment surface 22a tends to be visually recognized as a dark portion. In contrast to this, light with which the side surface 22b of the lattice-shaped support portion 22 is irradiated is scattered by the light scattering portion 25, and hence easily reaches the abutment, surface 22a of the lattice-shaped support portion 22. Consequently, it is difficult to visually recognize the abutment surface 22a as a dark portion, thereby suppressing the occurrence of luminance irregularity. Referring to FIG. 5, the optical paths of light with which the side surface 22b of the lattice-shaped support portion 22 is irradiated are indicated by the chain lines.

As shown in FIG. 5, each light scattering portion 25 is formed from the rough surface formed on the side surface 22b of the lattice-shaped support portion 22. This rough surface includes many fine recesses and projections, and is formed by, for example, applying a surface roughening treatment (for example, sand blasting) to the side surface 22b of the lattice-shaped support portion 22 after the support member 18 is resin-molded. Note that portions on which the light scattering portions 25 should not be formed (the frame-shaped support portion 21, the abutment surfaces 22a of the lattice-shaped support portion 22, and the like) may be masked at the time of a surface roughening treatment. Rough surfaces as the light scattering portions 25 can be formed by a technique other than the above technique. For example, many fine recesses and projections are formed in advance in the molding surfaces of a mold used for resin molding of the support member 18, which correspond to the side surfaces 22b, and the recesses and the projections are transferred onto the side surfaces 22b at the time of resin molding. This forms the light scattering portions 25 on the side surfaces 22b along with the manufacture of the support member 18, thus eliminating the necessity to perform a surface roughening treatment and the necessity to mask portions on which the light scattering portions 25 should not be formed. In any case, rough surfaces as the light scattering portions 25 can be formed at the manufacture of the support member 18 (lattice-shaped support portion 22) or can be formed by processing the lattice-shaped support portion 22 of the manufactured support member 18. Accordingly, this technique is superior In manufacturing cost and convenience to, for example, a technique of blending light scattering particles that scatter light in a lattice-shaped support portion.

This embodiment has the above structure. The function and operation of the structure will be described next. When the liquid crystal display device 10 having the above arrangement is powered on, a panel control circuit on a control board (not shown) controls drive of the liquid crystal panel 11. In addition, drive power from an LED drive circuit on an LED drive circuit board (not shown) is supplied to each LED 14 on the LED substrate 15, thereby controlling its drive.

At this time, the LED drive circuit performs so-called local dimming control of selectively turning on the LEDs 14 arranged near a bright portion of an image displayed on the display surface (for example, the LEDs 14 overlapping the bright portion) and turning off the LEDs 14 arranged near a dark portion of the image (for example, the LEDs 14 overlapping the dark portion) on the basis of image signals supplied to the liquid crystal panel 11. As shown in FIGS. 1 and 4, the LEDs 14 are respectively arranged in the partition spaces S each partitioned by the lattice-shaped support portion 22 constituting the support member 18. This makes it difficult for light from the ON LEDs 14 to enter the partition spaces S in which the OFF LEDs 14 are arranged. Accordingly, although a relatively large amount of light is supplied to a portion, of the effective light exit region of the optical member 17, which is located near a bright portion of the image displayed on the display surface of the liquid crystal panel 11, a relatively small amount of light is supplied to a portion, of the effective light exit region, which is located near a dark portion. This improves the contrast characteristics associated with the image displayed on the display surface of the liquid crystal panel 11, thus obtaining high display quality. On the other hand, because the support member 18 has light transmissivity, light is transmitted between the adjacent partition spaces S to some extent. This makes it difficult for the user to visually recognize the boundaries between the adjacent partition spaces S, thereby achieving excellent display quality.

As shown in FIGS. 2 and 3, light emitted from the light-emitting surface 14a of each LED 14 enters the light incident surface 17a of the optical member 17 directly or indirectly, exits from the light exit surface 17b after being given an optical effect by the optical member 17, and irradiates the liquid crystal panel 11. In addition to the direct light from each LED 14, light reflected by the reflecting sheet 16 and light transmitted through the lattice-shaped support portion 22 of the support member 18 enter the light incident surface 17a of the diffusion plate 19, of the optical member 17, which is disposed closest to the LED 14. Part of such light which is transmitted through the lattice-shaped support portion 22 is scattered by the light scattering portion 26 provided on the side surface 22b of the lattice-shaped support portion 22 to become omnidirectional light that has lost directivity. Accordingly, a sufficient amount of light transmitted through the lattice-shaped support portion 22 is also incident on a portion, of the light incident surface 17a of the diffusion plate 19, against which the abutment surface 22a of the lattice-shaped support portion 22 abuts, and is given a diffusion effect, thereby making it difficult to visually recognize the abutment surface 22a of the lattice-shaped support portion 22 as a lattice-shape dark portion. This uniformizes the luminance distribution of light exiting from the backlight device 12 and improves the display quality of images displayed on the display surface of the liquid crystal panel 11. Note that the light transmitted through the lattice-shaped support portion 22 includes light that indirectly irradiates the side surface 22b of the lattice-shaped support portion 22 after being reflected by the reflecting sheet 16 in addition to light that is emitted from the LED 14 and directly irradiates the side surface 22b of the lattice-shaped support portion 22.

As described above, the backlight device (lighting device) 12 according to this embodiment includes the plurality of LEDs (light sources) 14 planarly arranged at intervals, the optical member 17 disposed to face the plurality of LEDs 14 with a space between them, the lattice-shaped support portion (light-transmissive support portion) 22 having light transmissivity which is disposed so as to be interposed between the adjacent LEDs 14 and is supported by being brought into contact with the optical member 17 from the LED 14 side, and the light scattering portions 25 provided on the side surface 22b, which is at least an irradiation portion irradiated with light from the LED 14, so as to scatter light.

With this arrangement, light emitted from the plurality of LEDs 14 planarly arranged at intervals exits to the outside after being given an optical effect by the optical member 17 disposed on the light exit side to face the plurality of LEDs 14 with a space between them. Toe lattice-shaped support portion 22 is brought into contact with the optical member 17 from the LED 14 side to support the optical member 17, thereby holding the space between the plurality of LEDs 14 and the optical member 17. Although the lattice-shaped support portion 22 is disposed to be interposed between the adjacent LEDs 14, because the lattice-shaped support portion 22 has light transmissivity, it prevents light from each LED 14 from being shielded. This makes it difficult for the user to visually recognize the overall lattice-shaped support portion 22 as a dark portion. On the other hand, because it is difficult for light transmitted through the lattice-shaped support portion 22 to reach the abutment surface 22a as an abutment portion of the lattice-shaped support portion 22 against the optical member 17, the abutment surface 22a as the abutment portion can be a dark portion. In contrast to this, because the side surface 22b as a light irradiation portion of the lattice-shaped support portion 22 which is irradiated with at least light from each LED 14 is provided with the light scattering portion 25 that scatters light, when the lattice-shaped support portion 22 is irradiated with light from the LED 14, the light is scattered by the light scattering portion 25 provided on the side surface 22b as the light irradiation portion. Accordingly, at least part of the light reaches the abutment surface 22a as an abutment portion of the lattice-shaped support portion 22 against the optical member 17. This makes it difficult to visually recognize, as a dark portion, the abutment surface 22a as the abutment portion of the lattice-shaped support portion 22 against the optical member 17, thereby suppressing the occurrence of luminance irregularity.

Each light scattering portion 25 is formed from a rough surface formed on the side surface 22b as a light irradiation portion of the external surface of the lattice-shaped support portion 22. With this arrangement, light from each LED 14 with which the side surface 22b as a light irradiation portion of the external surface of the lattice-shaped support portion 22 is irradiated is scattered by the light scattering portion 25 formed from the rough surface formed on the side surface 22b. Accordingly, at least part of the light reaches the abutment surface 22a as an abutment portion of the lattice-shaped support portion 22 against the optical member 17, thereby making it difficult to visually recognize, as a dark portion, the abutment surface 22a as the abutment portion. Such rough surfaces can be formed at the manufacture of the lattice-shaped support portion 22 or can be formed by processing the manufactured lattice-shaped support portion 22. Accordingly, this technique is superior in manufacturing cost and convenience to, for example, a technique of blending light scattering particles that, scatter light in a lattice-shaped support portion.

The lattice-shaped support portion 22 has a partition wall shape that partitions between the adjacent LEDs 14. This makes the lattice-shaped support portion 22 having the partition wall shape partition between the adjacent LEDs 14, and hence makes it difficult for light from the ON LED 14 to leak to the OFF LED 14 in, for example, so-called local dimming control of selectively controlling ON/OFF of the plurality of LEDs 14. This makes it possible to control the amount of light exiting from the backlight device 12 for each area. In addition, because each abutment surface 22a as an abutment portion of the lattice-shaped support portion 22 against the optical member 17 has a linear shape, the lattice-shaped support portion 22 supports the optical member 17 with higher stability than when, for example, the abutment surface as the abutment portion has a dot shape.

The lattice-shaped support portion 22 has a lattice shape that individually partitions between the plurality of LEDs 14. This makes the lattice-shaped support portion 22 having the lattice shape individually partition between the plurality of LEDs 14, and hence can control the amount of light exiting from the backlight device 12 for each smaller area. In addition, because the mechanical strength of the lattice-shaped support portion 22 increases, the lattice-shaped support portion 22 supports the optical member 17 with higher stability.

The optical member 17 includes at least the diffusion plate (planar diffusion material) 19 that diffuses light. With this arrangement, light from each LED 14 exits to the outside while being diffused by the diffusion plate 19. When at least part of light, of light from the LED 14, which is diffused by the light scattering portion 25 of the lattice-shaped support portion 22 reaches the abutment surface 22a as an abutment portion of the lattice-shaped support portion 22 against the diffusion plate 19, the light exits to the outside while being diffused by the diffusion plate 19. This makes it difficult to visually recognize, as a dark portion, the abutment surface 22a as the abutment portion of the lattice-shaped support portion 22 against the diffusion plate 19.

The liquid crystal display device (lighting device) 10 according to this embodiment includes the backlight device 12 and the liquid crystal panel (display panel) 11 that displays images by using light applied from the backlight device 12. The liquid crystal display device 10 having this arrangement suppresses the occurrence of luminance irregularity of light from the backlight device 12, and hence can implement display with excellent display quality.

### Second Embodiment

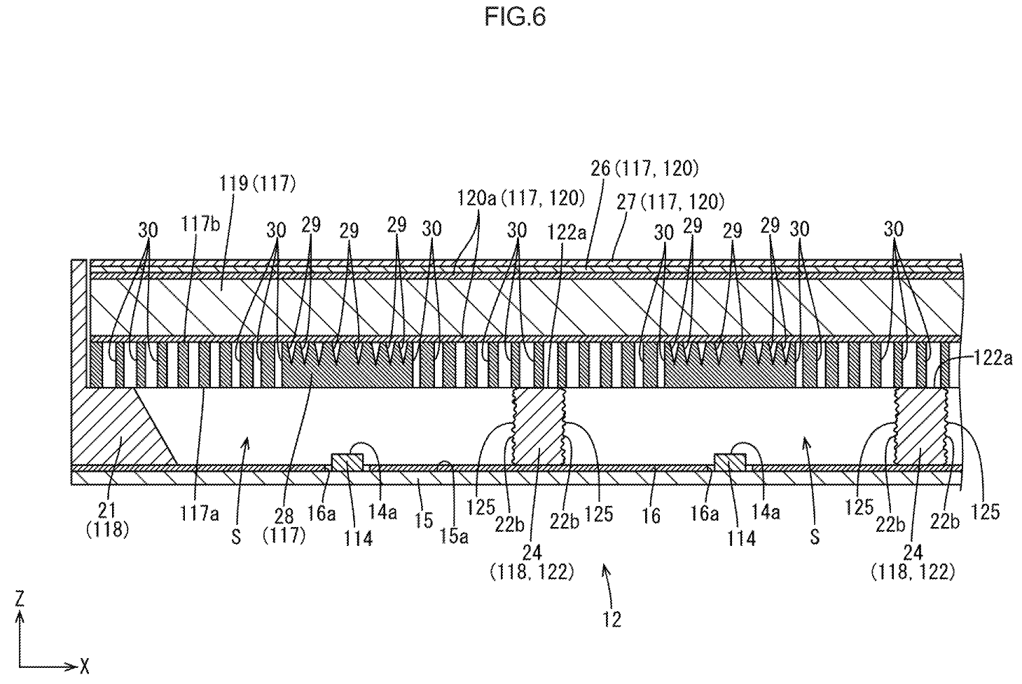

The second embodiment of the present invention will be described with reference to FIG. 6. The second embodiment will exemplify the arrangement of an optical member 117 as a modification. Note that redundant descriptions about the same structures, operations, and effects as those of the first embodiment described above will be omitted.

As shown in FIG. 6, the optical member 117 according to the second embodiment includes a prism sheet 26 and a reflective polarizing sheet 27, which are optical sheets 120, and a reflecting plate 28 with light-transmissive portions (a planar reflecting material with light-transmissive portions) in addition to a diffusion plate 119 and a diffusion sheet 120a which have the same arrangements as those in the first embodiment described above. The optical sheets 120 will be described first The optical sheets 120 include a total of four sheets including the two diffusion sheets 120a, the prism sheet 26, and the reflective polarizing sheet 27, with the prism sheet 26 being stacked on the front side relative to the front-side diffusion sheet 120a, the diffusion plate 119 being sandwiched between the two diffusion sheets 120a from the front and back sides, and the reflective polarizing sheet 27 being stacked on the front side relative to the prism sheet 26. Many prisms extending along the X-axis direction or Y-axis direction are arranged side by side on the plate surface of the base material of the prism sheet 26 along the Y-axis direction or X-axis direction to selectively give a light condensing effect to transmitted light only in the arranging direction of the prism. The reflective polarizing sheet 21 is constituted by a reflective polarizing film that polarizes and reflects light and a pair of diffusion films sandwiching the reflective polarizing film from the front and back sides. The reflective polarizing sheet 27 transmits the p-waves contained in transmitted light and reflects the s-waves, thereby improving utilization efficiency (that is, luminance) of light by reusing the s-waves that are generally absorbed by the polarizing plate of a liquid crystal panel (not shown).

As shown in FIG. 6, the reflecting plate 28 with the light-transmissive portions is disposed on the back side relative to the diffusion sheet 120a on the back side, that is, the most back side (near an LED 114) of the optical member 117. Accordingly, the reflecting plate 28 with the light-transmissive portions serves as the optical member 117 directly supported by a support member 118. The reflecting plate 28 with the light-transmissive portions is formed from a synthetic resin material (for example, polycarbonate) having a white surface with excellent reflectivity, and has a plate base material having the same thickness as that of the diffusion plate 119. Although the reflecting plate 28 with the light-transmissive portions has a light reflecting function obtained by making the base material reflect light, part of the base material is provided with groove portions 29 and opening portions 30 so as to make the reflecting plate 28 with the light-transmissive portions also have a light-transmissive function by making the groove portions 29 and the opening portions 30 transmit light. That is, the groove portions 29 and the opening portions 30 constitute “light-transmissive portions” that transmit light. The groove portions 29 are formed by recessing the surface of the base material of the reflecting plate 28 with the light-transmissive portions. With this structure, portions of the base material in which the groove portions 25 are formed are partially thinner than the remaining portions. Accordingly, the portions, of the base material, in which the groove portions 25 are formed transmit light more easily than the portions in which no groove portions 29 are formed. On the other hand, the opening portions 30 are formed so as to extend through the base material of the reflecting plate 28 with the light-transmissive portions along the thickness direction (Z-axis direction). This makes the opening portions 30 transmit light. The opening portions 30 are higher in light transmissivity than the groove portions 29. The groove portions 29 are arranged at positions relatively close to the LEDs 114 (positions far from a lattice-shaped support portion 122) within a light incident surface 117a of the reflecting plate 28 with the light-transmissive portions. In contrast, the opening portions 30 are arranged at positions relatively far from the LED 114 (positions close to the lattice-shaped support portion 122) within the light incident surface 117a of the reflecting plate 28 with the light-transmissive portions.

As shown in FIG. 6, the distribution densities of the groove portions 29 and the opening portions 30 within the light incident surface 117a of the reflecting plate 23 with the light-transmissive portions increase with an increase in distance from the LED 114, and decrease with a decrease in distance from the LED 114. More specifically, a plurality of the groove portions 29 decrease in array interval with an increase in distance from the LED 114 along the light incident surface 117a of the reflecting plate 28 with the light-transmissive portions, and increase in array interval with a decrease in distance from the LED 114. The groove portions 29 are hardly arranged at positions overlapping the LEDs 114. That is, the groove portions 29 and the opening portions 30 are hardly formed in most part of the reflecting plate 23 with the light-transmissive portions which overlaps the LEDs 114. Each opening portion 30 increases in opening width with an increase in distance from the LED 114 along the light incident surface 117a of the reflecting plate 28 with the light-transmissive portions. In contrast, with a decrease in distance to the LED 114, a plurality of opening portions 30 are formed so as to nave smaller opening widths with a decrease in distance to the LED 114. Of the opening portions 30, the opening portion adjacent to the groove portion 29 has the minimum opening width, whereas the opening portion 30 disposed to overlap the lattice-shaped support portion 122 has the maximum opening width. It is preferably designed such that the ratio of the area of the opening portions 30 to a unit area on the light incident surface 117a of the reflecting plate 28 with the light-transmissive portions, that is, the opening ratio of the opening portions 30, is, for example, proportional to the square of the distance from the LED 114.

The light amount distribution in each partition space S has a tendency of increasing with a decrease in distance from the LED 114 and decreasing with an increase in distance from the LED 114. In contrast to this, as described above, the distribution densities of the groove portions 29 and the opening portions 30 within the light incident surface 117a of the reflecting plate 23 with the light-transmissive portions increase with an increase in distance from the LED 114. This makes it difficult for a relatively large amount of light existing near the LED 114 to be transmitted through the groove portions 29 and the opening portions 30. Such light is reflected by the reflecting plate 28 with the light-transmissive portions to suppress the exit of light to the outside. In contrast to this, this arrangement suppresses the reflection of a relatively small amount of light exiting far from the LED 114 by the reflecting plate 28 with the light-transmissive portions. This makes it easy for such light to be transmitted through the groove portions 29 and the opening portions 30, thereby promoting the exit of light to the outside. As described above, the amount of light exiting from a light exit surface 117b of the reflecting plate 28 with the light-transmissive portions are uniformized within a plane. In addition, the opening portions 30 overlapping the lattice-shaped support portion 122 have the maximum opening width This makes it easy for light scattered by a light scattering portion 125 and transmitted through an abutment surface 122a of the lattice-shaped support portion 122 to be transmitted through the opening portions 30, thereby making it difficult to visually recognize the abutment surface 122a as a dark portion. Note that some light that has reached the abutment surface 122a cannot be transmitted through the opening portions 30 and is returned to the back side again by being reflected by the reflecting plate 28 with the light-transmissive portions.

As described above, according to this embodiment, the optical member 117 is a reflecting plate (planar reflecting material) that reflects light and includes at least the reflecting plate 28 with the light-transmissive portions (the planar reflecting material with the light-transmissive portions) having the groove portions 29 and the opening portions 30 serving as light-transmissive portions, with their distribution densities increasing with an increase in distance from each LED 114. With this arrangement, when light from the LED 114 reaches the groove portions 25 and the opening portions 30 as the light-transmissive portions of the reflecting plate 28 with the light-transmissive portions, the light exits to the outside. In contrast, when light is reflected by portions, of the reflecting plate 28 with the light-transmissive portions, in which the groove portions 29 and the opening portions 30 are not formed, the light is returned to the LED 114 side and then reaches the groove portions 29 and the opening portions 30 as the light-transmissive portions to exit to the outside. Because the distribution densities of the groove portions 29 and the opening portions 30 as the light-transmissive portions in the reflecting plate 23 with the light-transmissive portions increase with an increase in distance from the LED 114, the exit of light to the outside is suppressed near the LED 114 where the amount of light from the LED 114 is relatively large, whereas the exit of light to the outside is promoted at positions far from the LED 114 where the amount of light from the LED 114 is relatively small. This uniformizes the amounts of light exiting to the outside. A least part of light from each LED 114 which is scattered by the light scattering portion 125 of the lattice-shaped support portion 122 reaches the abutment surface 122a, of the lattice-shaped support portion 122, which is an abutment portion against the reflecting plate 28 with the light-transmissive portions. When the light is transmitted through the groove portions 28 and the opening portions 30 as the light-transmissive portions, the light exits to the outside. In contrast, when the light is reflected by the reflecting plate 28 with the light-transmissive portions, the light is returned to the LED 114 side again.

### Third Embodiment

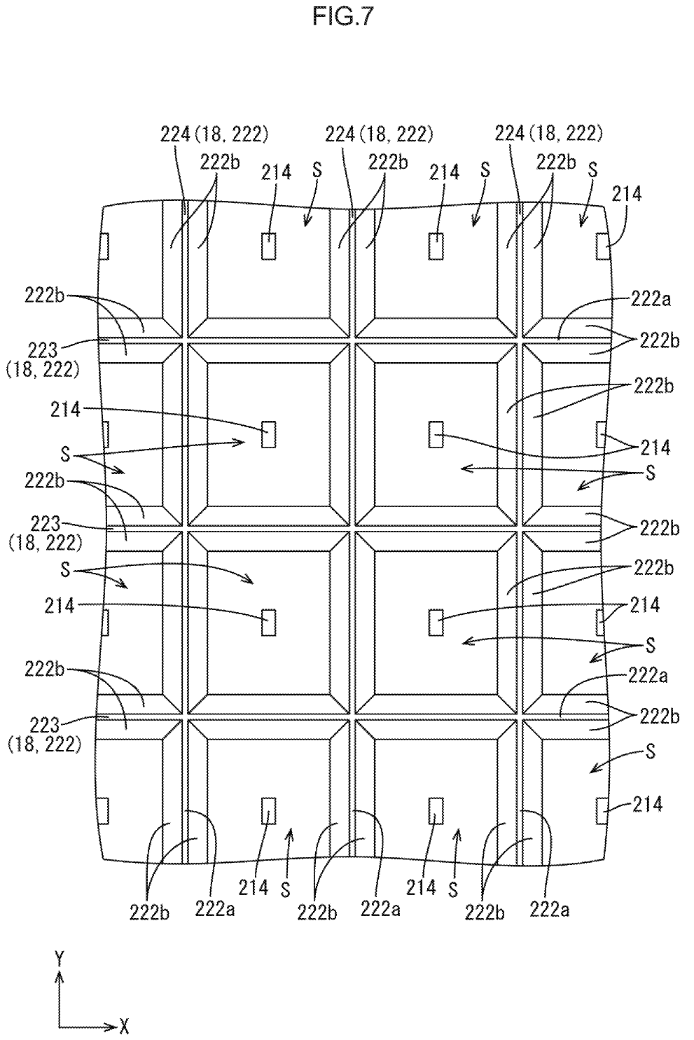

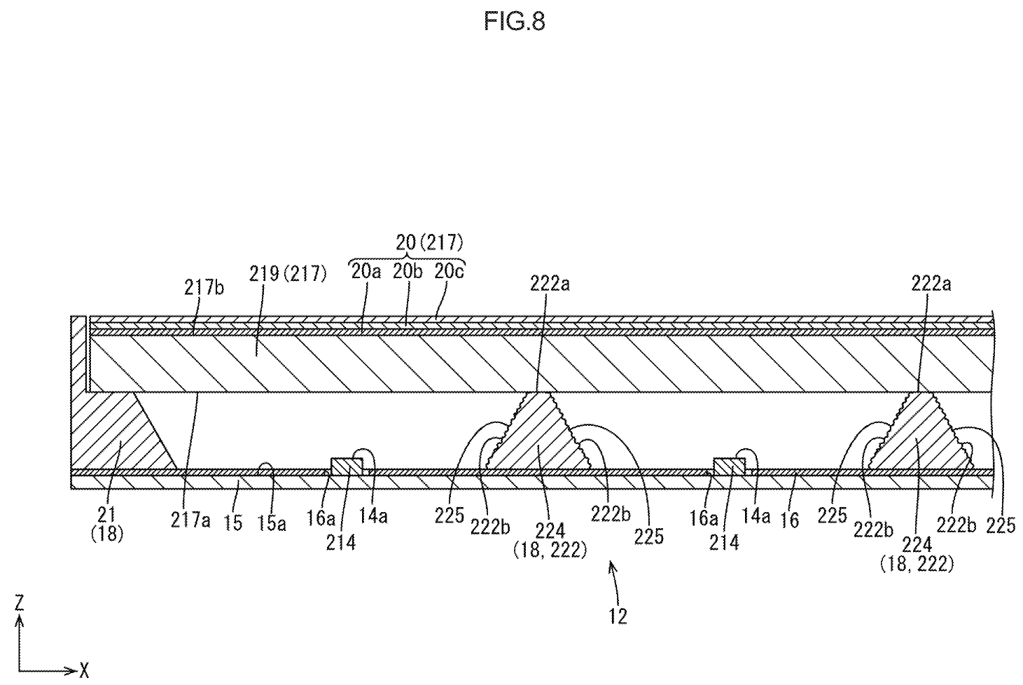

The third embodiment of the present invention will be described with reference to FIG. 7 or 8. The third embodiment will exemplify the arrangement of a lattice-shaped support portion 222 as a modification of the first embodiment. Note that redundant descriptions about the same structures, operations, and effects as those of the first embodiment described above will be omitted.

As shown in FIGS. 7 and 8, the lattice-shaped support portion 222 according to the third embodiment is formed such that side surfaces 222b having light scattering portions 225 are inclined with respect to the X-axis direction or Y-axis direction More specifically, each side surface 222b of the lattice-shaped support portion 222 is inclined with respect to the arranging direction of LEDs 214 (a light incident surface 217a of a diffusion plate 219) so as to increase in distance from the LED 214 in the X-axis direction or Y-axis direction with a decrease in distance from a diffusion plate 219 as a support target in the X-axis direction. More specifically, the inclination angle of each side surface 222b of the lattice-shaped support portion 222 with respect to the arranging direction of the LEDs 214 preferably falls within the range of, for example, 35° to 70°. Accordingly, first partition walls 223 and second partition walls 224 constituting the lattice-shaped support portion 222 each decrease in width dimension with a decrease in distance from the diffusion plate 219 (an increase in distance from the LED 214) in the Z-axis direction, and increases in width dimension with a decrease in distance from the LED 214 (an increase in distance from the diffusion plate 219) in the Z-axis direction. In addition, each partition space S partitioned by the lattice-shaped support portion 222 widens with a decrease in distance from the diffusion plate 219 in the Z-axis direction (an increase in distance from the LED 214), and narrows with a decrease in distance from the LED 214 in the Z-axis direction (an increase in distance from the diffusion plate 219). This arrangement can reduce the area of each abutment surface 222a as an abutment portion of the lattice-shaped support portion 222 against the diffusion plate 219 as compared with the first embodiment in which each side surface 22b of the lattice-shaped support portion 22 is perpendicular to the arranging direction of the LEDs 14 (see FIGS. 2 and 3). This makes it difficult to visually recognize each abutment surface 222a of the lattice-shaped support portion 222 as a dark portion. Accordingly, this arrangement is more suitable to suppress the occurrence of luminance irregularity. Note that the diameter dimension of each abutment surface 222a is preferably 1 mm or more in terms of guaranteeing the support stability of an optical member 217.

As described above, according to this embodiment, each external surface of the lattice-shaped support portion 222 is inclined with respect to the arranging direction of the LEDs 214 so as to increase in distance from the LED 214 as the external surface approaches the optical member 217. This can reduce the area of each abutment surface 222a as an abutment portion of the lattice-shaped support portion 222 against the optical member 217 as compared with a case in which, for example, each external surface of the lattice-shaped support portion is perpendicular to the arranging direction of the LEDs 214. This makes it further difficult to visually recognize each abutment surface 222a as an abutment portion of the lattice-shaped support portion 222 against the optical member 217 as a dark portion. It is therefore more suitable to suppress the occurrence of luminance irregularity.

### Fourth Embodiment

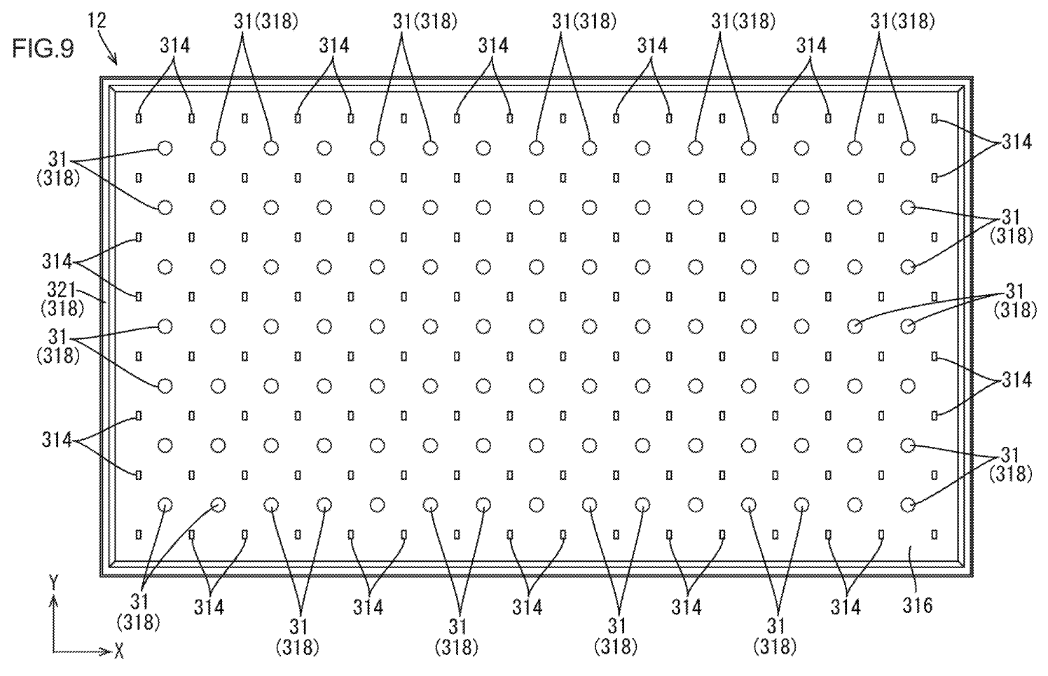

The fourth embodiment of the present invention will be described with reference to FIGS. 9 to 11. The fourth embodiment will exemplify the arrangement of a support member 318 as a modification of the first embodiment. Note that redundant descriptions about the same structures, operations, and effects as those of the first embodiment described above will be omitted.

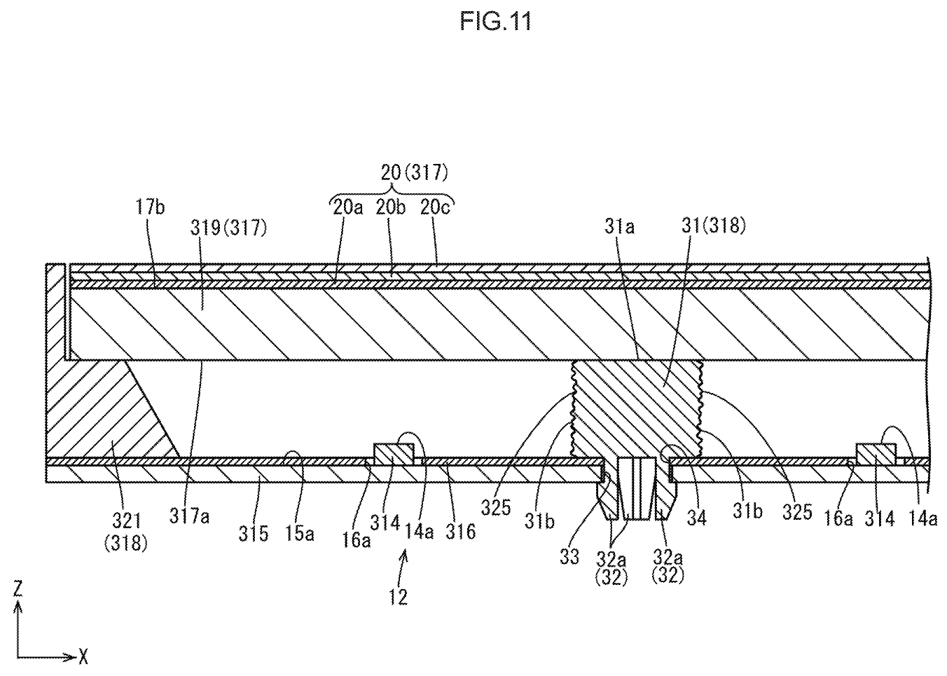

As shown in FIGS. 9 and 11, a support member 318 according to this embodiment is constituted by a frame-shaped support portion 321 and a plurality of columnar support portions (light-transmissive support portions) 31 that are parts discrete from the frame-shaped support portion 321. Of these parts, the frame-shaped support portion 321 corresponds to a part obtained by removing the lattice-shaped support portion 22 from the support member 18 described in the first embodiment, and supports the outer circumferential end portion (ineffective light exit region) of an optical member 317 from the back side. Each columnar support portion 31 is made of an almost transparent synthetic resin material with excellent light transmissivity like the support member 18 described in the first embodiment. The columnar support portion 31 is disposed at a position inwardly separate from the frame-shaped support portion 321 and interposed between a reflecting sheet 316 and the optical member 317 (a diffusion plate 319) in the Z-axis direction to support the central portion of the optical member 317 from which the outer circumferential end portion is removed, that is, the effective light exit region, from the back side.

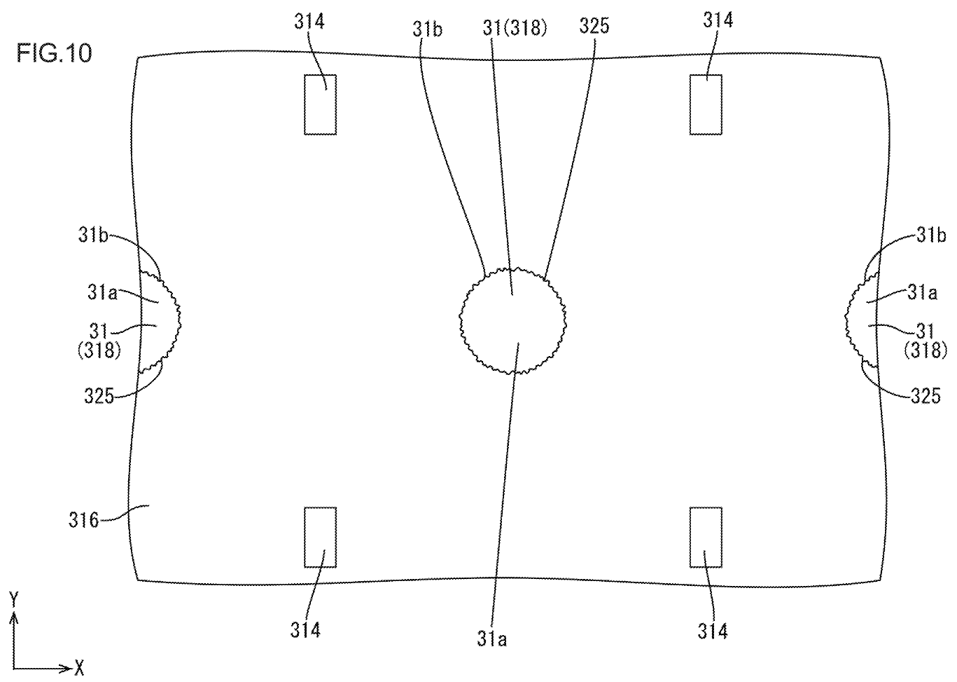

More specifically, as shown in FIGS. 9 and 10, each columnar support portion 31 has an almost cylindrical shape whose diameter dimension is almost constant throughout the height range, and is formed into a structure independent of the frame-shaped support portion 321. Accordingly, a surface of the columnar support portion 31 which faces the front side, that is, an abutment surface 31a against the optical member 317 (diffusion plate 319), has a planar shape parallel to a light incident surface 317a of the optical member 317, whereas a side surface 31b having a light scattering portion 325 is almost perpendicular to the light incident surface 317a of the optical member 317. The columnar support portions 31 are planarly arranged so as to be interposed between LEDs 314 of the LEDs 314 arranged in a matrix pattern, which are adjacent to each other in an oblique direction with respect to the X-axis direction and the Y-axis direction. More specifically, the columnar support portion 31 is disposed at the intersection point between two lines connecting the LEDs 314, of the two pairs of the LEDs 314 respectively arranged in the X-axis direction and the Y-axis direction, which are located at diagonal positions, located at the intermediate position in the X-axis direction between the LEDs 314 adjacent to each other in the X-axis direction, and located at the intermediate position in the Y-axis direction between the LEDs 314 adjacent to each other in the Y-axis direction. Accordingly, the plurality of columnar support portions 31 are arranged side by side along the X-axis direction and the Y-axis direction, and then array intervals of the columnar support portions 31 are almost the same as those of the LEDs 314 arranged side by side along the X-axis direction and the Y-axis direction.

As shown in FIGS. 9 and 10, the abutment surface 31a of each columnar support portion 31 having the above arrangement has a dot shape within the light incident surface 317a of the optical member 317. Accordingly, this reduces the abutment area of the abutment surface 31a against the optical member 317 as compared with the case in which the abutment surface 22a of the lattice-shaped support portion 22 has a linear shape in the first embodiment described above. This makes it difficult to visually recognize the abutment surface 31a of the columnar support portion 31 as a dark portion, and hence is more suitable to suppress the occurrence of luminance irregularity. In addition, this arrangement requires a smaller amount of synthetic resin material used for all the columnar support portions 31 than for the lattice-shaped support portion 22 described in the first embodiment, and hence is suitable to reduce the manufacturing cost of the columnar support portions 31. Furthermore, as shown in FIGS. 10 and 11, because the light scattering portions 325 are provided on the side surfaces 31b of the columnar support portion 31 throughout the entire height range and the entire circumference, even if the columnar support portion 31 is irradiated with light from the LEDs 314 from all directions in the circumferential direction, the light can be properly scattered by the light scattering portions 325. This allows more light to reach the abutment surface 31a of the columnar support portion 31.

The columnar support portion 31 is attached to an LED substrate 315 having the following attachment structure. As shown in FIG. 11, the columnar support portion 31 has an attachment portion 32 protruding from a main body portion having an almost cylindrical shape toward the back side, that is, toward the LED substrate 315 side. The attachment portion 32 is constituted by four deformable pawl portions 32a. The attachment portion 32 is inserted into an attachment hole 33 and an insertion hole 34 respectively formed in correspondence with attachment positions of the columnar support portion 31 on the LED substrate 315 and the reflecting sheet 316, and is locked to the hole edge of the attachment hole 33 from the back side. With this structure, the columnar support portion 31 is held on the LED substrate 315 in a retained state.

As described above, according to this embodiment, the columnar support portion (light-transmissive support portion) 31 has a columnar shape. With this structure, each abutment surface 31a as an abutment portion of the columnar support portion 31 against the optical member 317 has a dot shape. Accordingly, this reduces the area of the abutment surface 31a of the columnar support portion 31 against the optical member 317 as compared with the case in which, for example, the abutment surface as the abutment portion has a linear shape. This makes it difficult to visually recognize, as a dark portion, the abutment surface 31a as the abutment portion of the columnar support portion 31 against the optical member 317, and hence is more suitable to suppress the occurrence of luminance irregularity. In addition, this arrangement is also suitable to reduce the manufacturing cost of the columnar support portion 31.

The light scattering portions 325 are provided on the side surfaces 31b as light irradiation portions of the columnar support portion 31 throughout the entire circumference. With this arrangement, even if the columnar support portion 31 having a columnar shape is irradiated with light from the LEDs 314 from all directions in the circumferential direction, the light can be properly scattered by the light scattering portions 325. This allows more light to reach the abutment surface 31a as an abutment of the columnar support portion 31 against the optical member 317.

### Fifth Embodiment

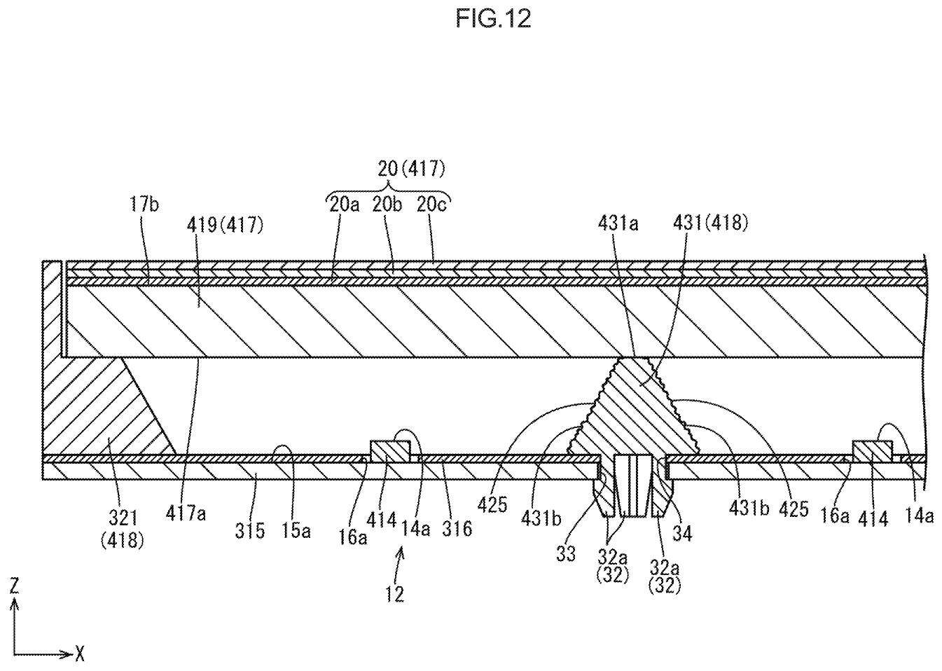

The fifth embodiment of the present invention will be described with reference to FIG. 12. The fifth embodiment will exemplify the arrangement of a columnar support portion 431 as a modification of the fourth embodiment. Note that redundant descriptions about the same structures, operations, and effects as those of the fourth embodiment described above will be omitted.

As shown in FIG. 12, the columnar support portion 431 constituting a support member 418 according to this embodiment is formed such that side surfaces 431b having light scattering portions 425 are inclined with respect to the X-axis direction or Y-axis direction. More specifically, each side surface 431b of the columnar support portion 431 is inclined with respect to the arranging direction of LEDs 414 (a light incident surface 417a of a diffusion plate 419) so as to increase in distance from the LED 414 in the X-axis direction or Y-axis direction with a decrease in distance from the diffusion plate 419 (an optical member 417) as a support target in the Z-axis direction. More specifically, the inclination angle of the side surface 431b of the columnar support portion 431 with respect to the arranging direction of the LEDs 414 preferably falls within the range of 35° to 70°. Accordingly, the columnar support portion 431 decreases in diameter dimension with a decrease in distance from the diffusion plate 419 (an increase in distance from the LED 414) in the Z-axis direction, and increases in diameter dimension with a decrease in distance from the LED 414 (an increase in distance from the diffusion plate 419) in the Z-axis direction. That is, the columnar support portion 431 has an almost conical shape (tapered shape). This arrangement, can reduce the area of an abutment surface 431a as an abutment portion of the columnar support portion 431 against the diffusion plate 419 as compared with the case in which the side surface 31b of the columnar support, portion 31 is perpendicular to the arranging direction of the LEDs 314 as in the fourth embodiment described above. This makes it difficult to visually recognize the abutment surface 431a of the columnar support portion 431 as a dark portion. Accordingly, this arrangement is more suitable to suppress the occurrence of luminance irregularity. Note that the diameter dimension of each abutment surface 431a is preferably 1 mm or more in terms of guaranteeing the support stability of the optical member 417.

### Sixth Embodiment

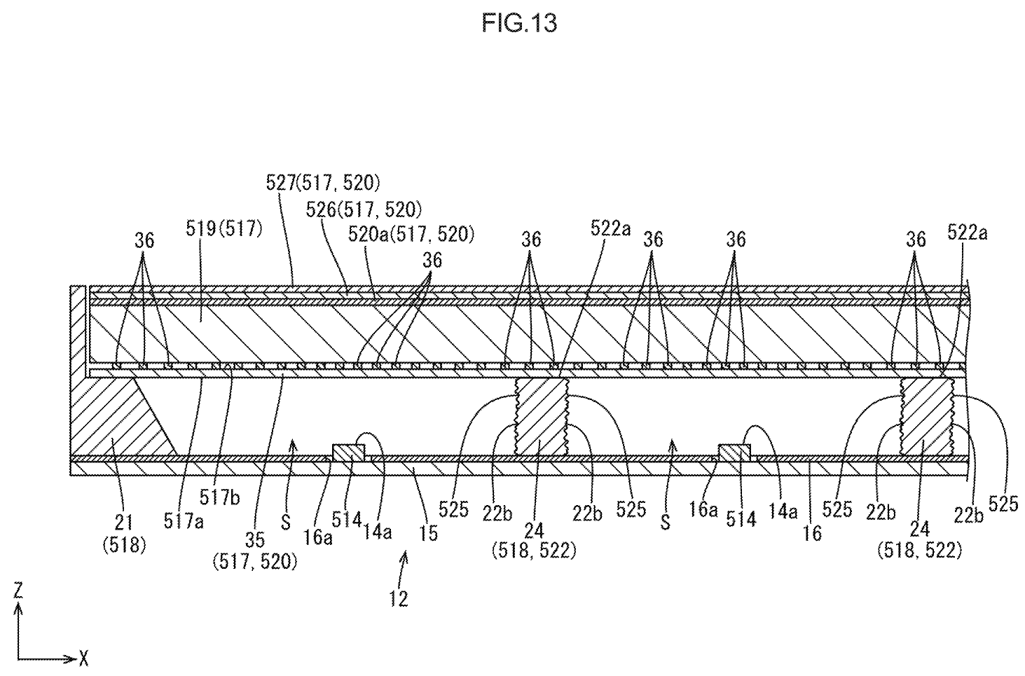

The sixth embodiment of the present invention will be described with reference to FIG. 13. The sixth embodiment will exemplify the arrangement of optical members 517 as a modification of the second embodiment. Note that redundant descriptions about the same structures, operations, and effects as those of the second embodiment described above will be omitted.

As shown in FIG. 13, the optical members 517 according to the sixth embodiment include a diffusion sheet 35 with reflecting portions (a planar diffusion material with reflecting portions) in place of the reflecting plate 28 with the light-transmissive portions described In the second embodiment, and a diffusion sheet 520a fewer by one than the diffusion sheets in the second embodiment. Optical sheets 520 include a total of four sheets including one each of the diffusion sheet 520a, a prism sheet 526, a reflective polarizing sheet 527, and the diffusion sheet 35 with the reflecting portions. The diffusion sheet 35 with the reflecting portions is stacked on the back side of a diffusion plate 519, and the diffusion sheet 520a is stacked on the front side of the diffusion plate 515. The prism sheet 526 is stacked on the front side of the diffusion sheet 520a, and the reflective polarizing sheet 527 is stacked on the front side of the prism sheet 526. As described above, this embodiment can reduce the number and thickness of the optical, members 517 to the extent corresponding to the reflecting plate 28 with the light-transmissive portions as compared with the second embodiment described above, thereby achieving reductions in cost and thickness.

As shown in FIG. 13, the diffusion sheet 35 with the reflecting portions is disposed on the most back side of the optical members 517 (near an LEDs 514), and is directly supported by a support member 518. The diffusion sheet 35 with the reflecting portions includes a base material having the same structure as that of the diffusion sheet 520a, and hence has a light diffusion function of diffusing transmitted light. The diffusion sheet 35 with the reflecting portions has reflecting portions 36 that are provided in part of a surface of the base material and reflect light, and hence has a light reflecting function in addition to the light diffusion function described above. The reflecting portions 36 are made of a white ink material having excellent light reflectivity, which is partly printed on the base material of the diffusion sheet 35 with the reflecting portions by, for example, an ink jet printing method. The plurality of reflecting portions 36 are arranged such that the distribution density within a light incident surface 517a of the diffusion sheet 35 with the reflecting portions decreases with an increase in distance from the LED 514, and increases with a decrease in distance from the LED 514. More specifically, the plurality of reflecting portions 36 are arranged such that the array intervals increase with an increase in distance from the LED 514 along the light incident surface 517a of the diffusion sheet 35 with the reflecting portions, and decrease with a decrease in distance from the LED 514. The array intervals between the reflecting portions 36 overlapping the LED 514 decrease most. In contrast, the array intervals between the reflecting portions 36 overlapping a lattice-shaped support portion 522 increase most. It is preferably designed such that the ratio of the area of the reflecting portions 36 to a unit area on the light incident surface 517a of the diffusion sheet 35 with the reflecting portions is, for example, proportional, to the square of the distance from the LED 514.

According to this arrangement, it is difficult for a relatively large amount of light existing near each LED 514 in a partition space S to be transmitted through the base material of the diffusion sheet 35 with the reflecting portions, and the light is reflected by the reflecting portion 36 to suppress the exit of the light to the outside. In contrast to this, the reflection of a relatively small amount of light existing far from the LED 514 by the reflecting portion 36 is suppressed. This makes it easy for the light to be transmitted through the diffusion sheet 35 with the reflecting portions, thereby promoting the exit of the light to the outside. As described above, the amounts of light exiting from a light exit surface 517b of the diffusion sheet 35 with the reflecting portions are uniformized within a plane. In addition, the array intervals between the reflecting portions 36 arranged to overlap each lattice-shaped support portion 522 are the maximum, and hence light scattered by a light scattering portion 525 and transmitted through an abutment surface 522a is easily transmitted through the base material of the diffusion sheet 35 with the reflecting portions. This makes it difficult for the user to visually recognize the abutment surface 522a as a dark portion. Note that light reaching the abutment surface 522a includes light reflected by the reflecting portion 36 and returned to the back side again without being transmitted through the based material of the diffusion sheet 35 with the reflecting portions.

As described above, according to this embodiment, the optical member 517 includes at least the diffusion sheet 35 with the reflecting portions (the planar diffusion material with the reflecting portions) that is a diffusion sheet (planar diffusion material) for diffusing light and has the reflecting portions 36 on the surface, with the distribution density of the reflecting portions decreasing with an increase in distance from the LED 514. With this arrangement, light from each LED 514 exits to the outside while being diffused upon reaching a portion, of the diffusion sheet 35 with the reflecting portions, on which the reflecting portions 36 are not formed. In contrast to this, when light is reflected by the reflecting portions 36, the light is temporarily returned to the LEE 514 side and exits to the outside while being diffused upon reaching a portion on which the reflecting portions 36 are not formed. The distribution density of the reflecting portions 36 on the diffusion sheet 35 with the reflecting portions decreases with an increase in distance from the LED 514. This suppresses the exit of light near the LED 514 at which the amount of light is relatively large, and promotes the exit of light to the outside at a position far from the LED 514 at which the amount of light is relatively small, thereby uniformizing the amount of light exiting to the outside. At least part of light from the LED 514 which is scattered by the light, scattering portion 525 of the lattice-shaped support portion 522 reaches the abutment surface 522a as an abutment portion of the lattice-shaped support portion 522 against the diffusion sheet 35 with the reflecting portions. This light exits while being diffused when transmitted through a portion on which the reflecting portions 36 are not formed, but is returned to the LED 514 side again when reflected by the reflecting portions 36.

### Seventh Embodiment

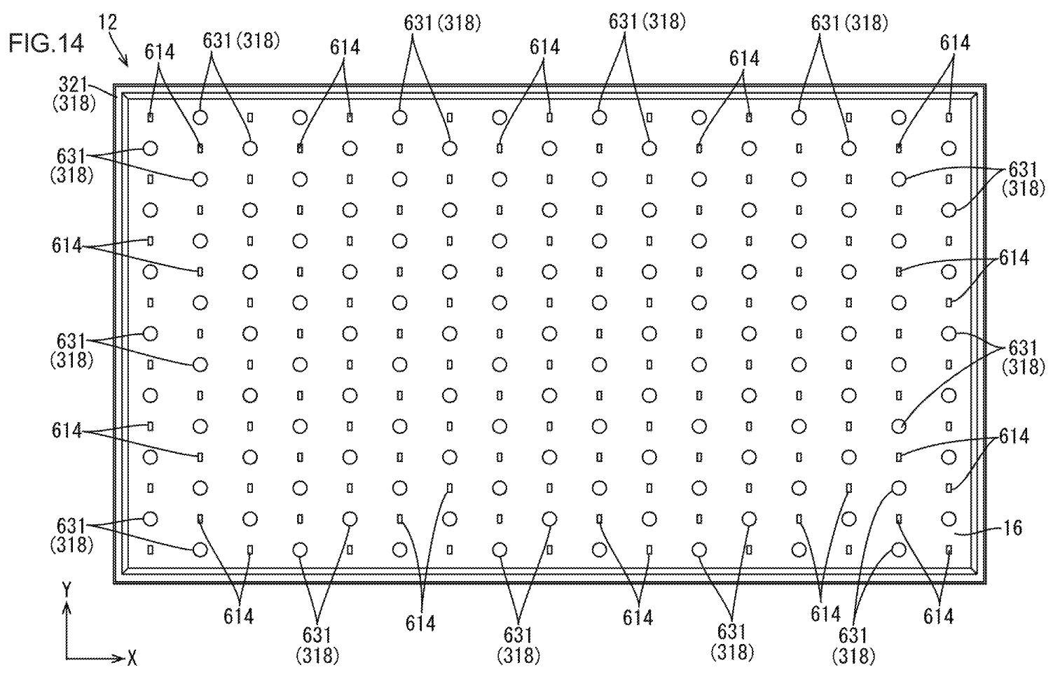

The seventh embodiment of the present invention will be described with reference to FIG. 14. The seventh embodiment will exemplify the arrangement of LEDs 614 and columnar support portions 631 as a modification of the fourth embodiment. Note that redundant descriptions about the same structures, operations, and effects as those of the fourth embodiment described above will be omitted.

As shown in FIG. 14, the LEDs 614 and the columnar support portions 631 according to the seventh embodiment are arranged in a staggered pattern (zigzag pattern) in a planar view. More specifically, the LEDs 614 and the columnar support portions 631 are alternately and repeatedly arranged side by side along the X-axis direction and the Y-axis direction. The columnar support portions 631 are respectively interposed between the LEDs 614 adjacent to each other in the X-axis direction and the Y-axis direction. The LEDs 614 are respectively interposed between the columnar support portions 631 adjacent to each other in the X-axis direction and the Y-axis direction. The LEDs 614 and the columnar support portions 631 are consecutively arranged side by side (without other members being interposed) along oblique directions with respect to the X-axis direction and the Y-axis direction. This arrangement can also obtain the same functions and effects as those of the fourth embodiment described above.

### Eighth Embodiment

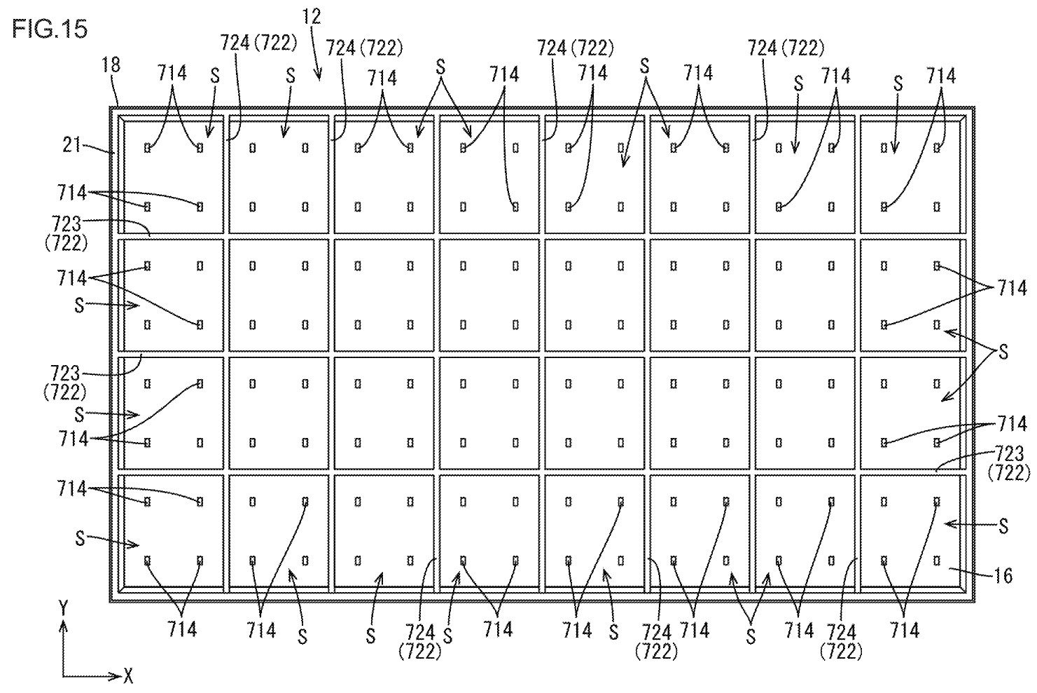

The eighth embodiment of the present invention will be described with reference to FIG. 15. The eighth embodiment will exemplify the arrangement of a lattice-shaped support portion 722 as a modification of the first embodiment. Note that redundant descriptions about the same structures, operations, and effects as those of the first embodiment described above will be omitted.

As shown in FIG. 15, the lattice-shaped support portion 722 according to the eighth embodiment is configured such that a plurality of LEDs 714 are arranged in partition spaces S. More specifically, first partition walls 723 and second partition walls 724 constituting the lattice-shaped support portion 722 are provided to collectively surround a total of four LEDs 714 arranged side by side in twos along the X-axis direction and the Y-axis direction. This arrangement can also obtain the same functions and effects as those of the first embodiment described above.

### Ninth Embodiment

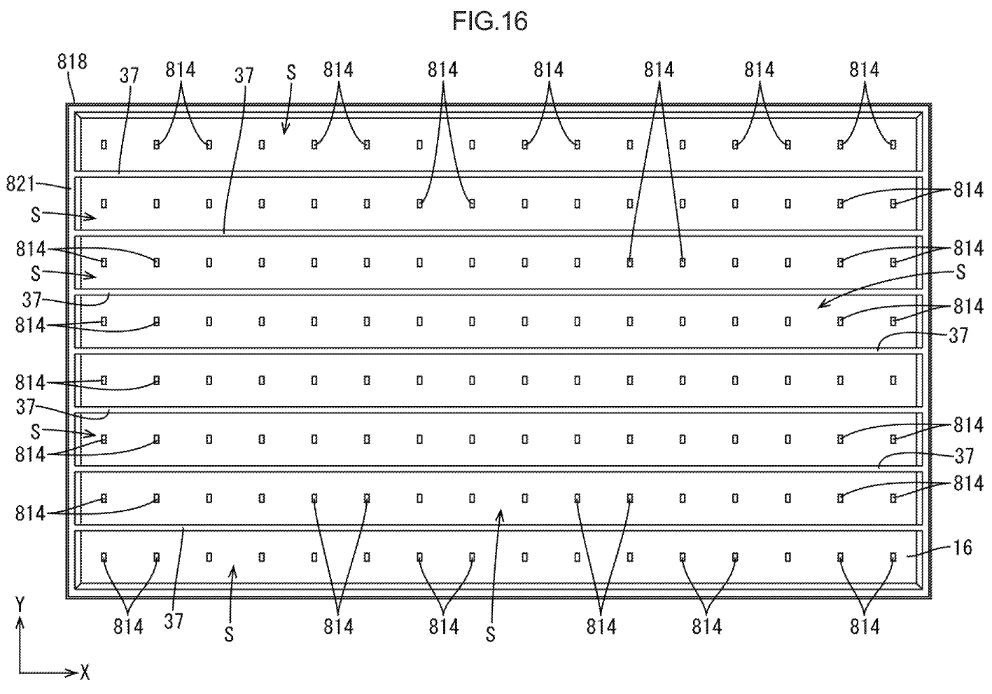

The ninth embodiment of the present invention will be described with reference to FIG. 16. The ninth embodiment will exemplify the arrangement of a support member 818 as a modification of the first embodiment. Note that redundant descriptions about the same structures, operations, and effects as those of the first embodiment described above will be omitted.

As shown in FIG. 16, the support member 818 according to the ninth embodiment is constituted by a frame-shaped support portion 821 and partition walls 37 linearly extending along the X-axis direction. The partition walls 37 continue between the internal surfaces of the two short side portions of the frame-shaped support portion 821 which extend along the Y-axis direction, and support the effective light exit region of the display screen 817 from the back side. The partition walls 37 are interposed between LEDs 814 arranged along the Y-axis direction to partition between the LEDs 814, and are arranged at intermediate positions between the LEDs 814 adjacent to each other in the Y-axis direction. That is, the partition walls 37 and the LEDs 814 are alternately arranged in the Y-axis direction. More specifically, the partition walls 37 are arrayed at an equal pitch in the Y-axis direction at the same intervals as those between the LEDs 814 adjacent to each other in the Y-axis direction. The number of placed partition walls 37 is the number obtained by subtracting 1 from the number of LEDs 814 arrayed in the Y-axis direction. Partition spaces S partitioned by the partition walls 37 each have a horizontally long shape extending along the X-axis direction. The plurality of LEDs 314 arranged along the X-axis direction are arranged in each partition space S. This arrangement can also obtain the same functions and effects as those of the first embodiment described above.

### 10th Embodiment

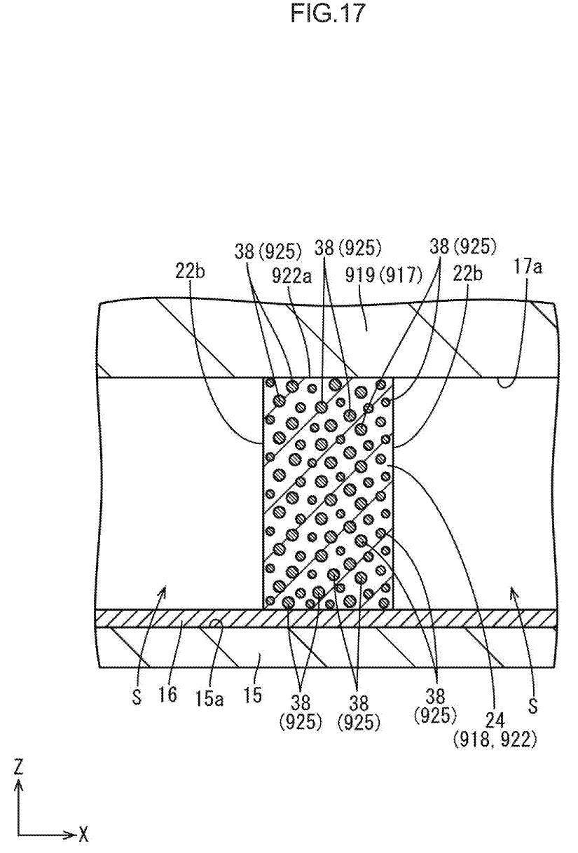

The 10th embodiment of the present invention will be described with reference to FIG. 17. The 10th embodiment will exemplify a light scattering portion 925 as a modification of the first embodiment. Note that redundant descriptions about the same structures, operations, and effects as those of the first embodiment described above will be omitted.

As shown in FIG. 17, the light scattering portion 925 according to the 10th embodiment is formed from light scattering particles 33 that scatter light. The light scattering particles 38 are embedded in a lattice-shaped support portion 922 by being dispersed and blended in a material for a support member 918 at the time of the manufacture of the support member 918. The light scattering particles 38 are dispersed in the lattice-shaped support portion 922 throughout almost the entire area, and hence exist in a light irradiation portion, of the lattice-shaped support portion 922, which is irradiated with light from an LED (not shown). Accordingly, the light with which the lattice-shaped support portion 922 is irradiated is scattered by the light scattering particles 38 constituting the light scattering portion 925. This makes it easy for the light to reach an abutment surface 922a of the lattice-shaped support portion 922 against a diffusion plate 919 (optical member 917), thereby making it difficult for the user to visually recognize the abutment surface 922a as a dark part. This makes it possible to suppress the occurrence of luminance irregularity.

### Other Embodiments

The present invention is not limited by the embodiments explained by the above description and the drawings. For example, the following embodiments are also included in the technical scope of the present invention.

(1) Although the first embodiment has exemplified the case in which the light scattering portions are provided on the side surfaces of the lattice-shaped support portion throughout almost the entire area, the specific formation range of light scattering portions on each side surface of the lattice-shaped support portion can be changed as needed. For example, light scattering portions may be provided on each side surface of the lattice-shaped support portion partly in the height direction. In addition, light scattering portions may be provided on each first partition wall and each second partition wall constituting the lattice-shaped support portion partly in the lengthwise direction (the X-axis direction or Y-axis direction).

(2) Although the fourth embodiment described above has exemplified the case in which the light scattering portions are provided on the side surfaces of the columnar support portion throughout the entire height range and the entire circumference, the specific formation range of the light scattering portions on each side surface of the columnar support portion can be changed as needed. For example, light scattering portions may be provided on each side surface of the columnar support portion partly in the height direction. Alternatively, light scattering portions may be provided on each side surface of the columnar support portion partly in the circumferential direction.

(3) Although the 10th embodiment has exemplified the case in which the light scattering particles constituting light scattering portions are dispersed in the lattice-shaped support portion throughout almost the entire area, the specific formation range of light scattering portions in the lattice-shaped support portion can be changed as needed. For example, light scattering particles constituting light scattering portions may be partially and unevenly provided in the lattice-shaped support portion.

(4) The specific arrangements (distributions), sizes, and the like of groove portions and opening portions in the reflecting plate with the light-transmissive portions in the second embodiment can be changed as needed.

(5) Although the second embodiment has exemplified the case In which the groove portions and the opening portions are provided in the reflecting plate with the light-transmissive portions, the reflecting plate with the light-transmissive portions may be provided with only the opening portions without being provided with any groove portions or may be provided only the groove portions without being provided with any opening portions on the reflecting plate with the light-transmissive.

(6) The arrangement (the reflecting plate with the light-transmissive portions) described in the second embodiment may be combined with the arrangements described in the third to 10th embodiments.

(7) The specific inclination angles of the side surfaces of the lattice-shaped support portion and the columnar support portion in the third and fifth embodiments described above can be changed as needed. In addition, the side surfaces of the lattice-shaped support portion and the columnar support portion may have inclined shapes bent stepwise.

(8) The arrangement (the inclined side surfaces of the lattice-shaped support portion) described in the third embodiment can be combined with the arrangements described in the sixth and eighth to 10th embodiments.

(9) Although the fifth and fifth embodiments described above each have exemplified the case in which the arranging directions of the columnar support portions and the LEDs are oblique with respect to the X-axis direction and the Y-axis direction, it is possible to adopt an arrangement in which columnar support portions are interposed between LEDs arranged in a matrix pattern along the X-axis direction and the Y-axis direction, and the arranging directions of the columnar support portions and the LEDs coincide with the X-axis direction and the Y-axis direction.

(10) The specific arrangements, numbers, and the like of the LEDs and the columnar support portions in other than the fourth, fifth, and seventh embodiments can be changed as needed.

(11) The arrangement (the oblique side surfaces of the columnar support portions) described in the fifth embodiment can be combined with the seventh embodiment.

(12) The specific arrangement (distribution), size, and the like of the reflecting portions on the diffusion sheet with the reflecting portions in other than the sixth embodiment can be changed as needed.

(13) The arrangement (diffusion sheet with the reflecting portions) described in the sixth embodiment can be combined with the arrangements described in the seventh to 10th embodiments.

(14) Although the eighth embodiment has exemplified the case in which four LEDs are arranged in one partition space, the number of LEDs arranged in one partition space can be changed as needed to a number other than four.

(15) Although the ninth embodiment has exemplified the arrangement in which the partition walls extend along the X-axis direction, the partition walls may extend along the Y-axis direction.

(16) Although the ninth embodiment has exemplified the case in which the partition walls and the LEDs are alternately arranged in the Y-axis direction, a plurality of LEDs may be interposed between adjacent partition walls.

(17) The 10th embodiment has exemplified the case in which the light scattering particles constituting the light scattering portions are embedded in the lattice-shaped support portion. This arrangement may be combined with the arrangements according to the fourth, fifth, and seventh embodiments described above such that light scattering particles constituting the light scattering portions are embedded in the columnar support portions.

(18) Although the 10th embodiment has exemplified the case in which the light scattering particles constituting the light scattering portions are embedded in the lattice-shaped support portion, light scattering particles may be applied on the side surfaces of the lattice-shaped support portion.

(19) The arrangement (light scattering particles) described in the 10th embodiment can be combined with the arranges described in the seventh to ninth embodiments.

(20) The specific number, types, stacking order, and the like of optical members in each embodiment described above can be changed as needed.

(21) Each embodiment described above has exemplified the case in which the base material of the LED substrate is a rigid substrate, the base material of the LED substrate may be a flexible substrate having flexibility.

(22) The specific number, arrangement pattern, and the like of LEDs in each embodiment described above can be changed as needed.

(23) Each embodiment described above has exemplified the case in which only one LED substrate is prepared, the LED substrate may be divided into a plurality of portions.

(24) The cover glass described in each embodiment may be provided with a touch panel pattern for the detection of a position touched by the user.

(25) A touch panel having a touch panel pattern may be provided independently of the cover glass described in each embodiment described above. When a touch panel is to be provided, the cover glass may be omitted.

(26) Each embodiment described above has exemplified the case in which the cover glass is installed, a protective film made of a synthetic resin may be installed instead of the cover glass. In addition, the cover glass or the protective film can be omitted.

(27) Each embodiment described above has exemplified the case in which the liquid crystal display device (the liquid crystal panel and the backlight device) has a horizontally long rectangular shape in a planar view, the liquid crystal display device may have, for example, a vertically long rectangular shape, square shape, oval shape, elliptic shape, circular shape, trapezoidal shape, or shape partially having a curved surface in a planar view.

(28) Although each embodiment described above has exemplified the case in which the LEDs are used as light sources, light sources (organic ELs) other than the LEDs can also be used.

(29) Each embodiment described above has exemplified the liquid crystal panel whose color filter has a three-color arrangement including red, green, and blue, the present invention can also be applied to a liquid crystal panel whose color filter has a four-color arrangement with yellow or white being added to red, green, and blue.

(30) Each embodiment described above has exemplified the liquid crystal panel having the liquid crystal layer being held between the pair of substrates, the present invention can also be applied to a display panel having functional organic molecules (medium layer), other than liquid crystal materials, held between a pair of substrates.

(31) Each embodiment described above uses the TFTs as the switching elements of the liquid crystal panel. However, the present invention can also be applied to a liquid crystal panel using switching elements (for example, thin-film diodes (TFDs)) other than TFTs and to a liquid crystal panel for monochrome display other than a liquid crystal panel for color display.

(32) Although each embodiment described above has exemplified the liquid crystal panel as a display panel, the present invention can also be applied to other types of display panels (for example, MEMS (Micro Electro Mechanical Systems) display panels).

### EXPLANATION OF SYMBOLS

10: liquid crystal display device (display device)

11: liquid crystal panel (display panel)

12: backlight device (lighting device)

14, 114, 214, 314, 414, 514, 614, 714, 814: LED (light source)

17, 117, 217, 317, 417, 517, 917: optical member

19, 119, 219, 319, 419, 519, 919: diffusion plate (planar diffusion material)

22, 122, 222, 522, 722, 922: lattice-shaped support portion (light-transmissive support portion)

22a, 122a, 222a, 522a, 922a: abutment surface (abutment portion)

22b, 222b: side surface (light irradiation portion)

25, 125, 225, 325, 425, 525, 525: light scattering portion

28: reflecting plate with light-transmissive portions (planar reflecting material with light-transmissive portions)

29: groove portion (light-transmissive portion)

30: opening portion (light-transmissive portion)

31, 431, 631: columnar support portion (light-transmissive support portion)

31a, 431a: abutment surface (abutment portion)

31b, 431b: side surface (light irradiation portion)

35: diffusion sheet with reflecting portions (planar diffusion material with reflecting portions)

36: reflecting portion

37: partition wall (light-transmissive support portion)

1. A lighting device comprising:
a plurality of light sources planarly arranged at intervals;
an optical member disposed on a light exit side to face the plurality of light sources at an interval;
a light-transmissive support portion disposed to be interposed between the adjacent light sources, configured to support the optical member by being brought into contact with the optical member from the light source side, and having light transmissivity; and
a light scattering portion provided on at least a light irradiation portion of the light-transmissive support portion irradiated with light from the light source.

2. The lighting device according to claim 1, wherein the light scattering portion is formed from a rough surface formed on the light irradiation portion on an external surface of the light-transmissive support portion.

3. The lighting device according to claim 1, wherein the light-transmissive support portion is inclined with respect to an arranging direction of the light sources so as to increase in distance from the light sources as the external surface approaches the optical member.

4. The lighting device according to claim 1, wherein the light-transmissive support portion has a partition wall shape partitioning between the adjacent light sources.

5. The lighting device according to claim 4, wherein the light-transmissive support portion has a lattice shape individually portioning the plurality of light sources.

6. The lighting device according to claim 1, wherein the light-transmissive support portion has a columnar shape.

7. The lighting device according to claim 6, wherein the light scattering portion is provided on the light irradiation portion of the light-transmissive support portion throughout an entire circumference.

8. The lighting device according to claim 1, wherein the optical member includes at least a planar diffusion material configured to diffuse light.

9. The lighting device according to claim 1, wherein the optical member includes at least a planar reflecting material with light-transmissive portions that is a planar reflecting material configured to reflect light, includes light-transmissive portions, and increases in distribution density of light-transmissive portions with an increase in distance from the light sources.

10. The lighting device according to claim 1, wherein the optical member includes at least a planar diffusion material with reflecting portions that is a planar diffusion material configured to reflect light, and decreases in distribution density of reflecting portions on the surface with an increase in distance from the light sources.

11. A display device comprising:
a lighting device according to claim 1; and
a display panel configured to display an image by using light applied from the lighting device.
